(19) United States
(12) Patent Application Publication
(10) Pub. No.: US 2023/0276887 A1
(43) Pub. Date: Sep. 7, 2023

(54) SYSTEM AND METHOD FOR MODELLING A CLOTH ARTICLE

(71) Applicant: TIRA TECHNOLOGIES PRIVATE LIMITED, Singapore (SG)

(72) Inventor: Li Hong Andrea QUEK, Singapore (SG)

(21) Appl. No.: 18/016,702

(22) PCT Filed: Jul. 21, 2021
(86) PCT No.: PCT/SG2021/050428

§ 371 Date: Jan. 18, 2023

(30) Foreign Application Priority Data
Jul. 21, 2020 (SG) 10202006978S

(51) Int. Cl. A41H 3/00; G06F 30/23; G06T 17/20

(52) U.S. Cl. CPC A41H 3/007; G06F 30/23; G06T 17/205; G06F 2113/12

(57) ABSTRACT

A system, apparatus and method of modelling a cloth article, comprising providing a 3D surface, the 3D surface is formed from a plurality of first points: providing a virtual textile comprising properties of a piece of cloth: generating a flat pattern representing 2D shapes that form the 3D surface and generating a cloth model to be simulated based on user interactions between the 3D surface, the virtual textile, and the flat pattern; updating the 3D surface based on the user interactions: and simulating the cloth model.

### CROSS-REFERENCE TO RELATED APPLICATION

This application claims the benefit of priority of Singapore Patent Application Ser. No. 10202006978S filed on 21 Jul. 2020 and titled “CLOTH MODELLING”, which is incorporated herein by reference in its entirety.

### TECHNICAL FIELD

The present invention relates to a system and method for modelling a cloth article, such as a garment. The present invention further relates to an apparatus, systems and methods for designing cloth articles.

### BACKGROUND

The design of cloth articles, such as garments, sheets, curtains, upholstery, and the like has been traditionally performed by hand. The process involves initial conceptualization and design. An initial pattern is produced based on the design, and the article is then made according to the initial pattern. The article is thereafter refined until it matches the design, and a final pattern is produced once the design has been satisfied. This process requires extensive experience, is labor intensive, involves a significant amount of trial and error and, importantly, time. Moreover, design refinements, being processes such as adjustments and correction of errors made after the article has been designed, consume textiles and can therefore be costly.

More recently, some of the refinement steps have taken advantage of computer aided design (CAD) programs. CAD programs can reduce the time taken to adjust a prototype cloth article and reduce consumption of materials prior to satisfying the design (i.e., when the article looks as intended). A CAD program typically takes a flat shape for a cloth article and assembles the flat shapes into the article. The CAD system facilitates pattern-cutting, digital sampling and the like, by helping a user visualize the appearance of articles they are working on.

Existing CAD programs cannot start the design process, nor can they accomplish the design process to a final pattern. The cloth represented by existing CAD programs does not replicate real world cloth behavior, and the boundaries of regions in the pattern produced by such CAD programs does not respect the stretch of cloth in various directions. As a result, once an existing CAD program outputs a pattern, the cloth article must be made from that pattern and must then be adjusted to ensure the cloth article satisfies the design in reality - only then can then final pattern be produced.

CAD programs typically require a user to provide the flat shape for the article or select from a suite of template components (e.g., sleeves, bodice, cuffs, and collar for a garment) or template designs. The article is then assembled based on the pattern or templates and displayed in a three-dimensional rendering. If the article does not satisfy the design, the flat shape for the article or template is adjusted. The adjusted pattern is reassembled and displayed. Understanding which adjustments to make requires a similar amount of experience and know-how as that required for traditional, manual design refinement, as well as an understanding of the limitations of the CAD program.

Existing CAD programs cannot realistically represent a textile from which the cloth article is intended to be produced. Existing CAD programs focus on modifying the flat shape and carrying modifications of the flat shape into a mesh of polygons built based on the shape of the article in three-dimensions. Particle-based cloth simulation models, as is the state of the art, are highly sensitive to the number and arrangement of points. The cloth simulation topology should be constructed in a deliberate manner to accurately reflect the properties of the textile. However, existing CAD programs base the cloth simulation topology directly on the three-dimensional mesh topology, when in many cases the three-dimensional mesh topology cannot and does not reflect the properties (e.g., stretch in various directions) of the textile. Therefore, it is often the case that the physical production of an article drawn up in existing CAD programs does not accurately match its digital counterpart in form and behavior.

Accordingly, there is a need for an improved apparatus, system and method for modelling cloth articles within computerized environments.

### SUMMARY

There is thus provided, in accordance with some embodiments of the present disclosure system, apparatus, and methods for modelling a cloth article within a computerized environment are provided. According to some embodiments, the methods comprise designing a cloth article on a computer. In some embodiments, a final pattern can be outputted directly from the computer. In other embodiments, the computer can instruct automated cloth article creation plant, for example by automated cloth laser cutting and stitching or sewing machines, to produce the cloth article directly from the final pattern. Thus, the methods can be implemented in a computer program, such as a CAD program, and used for all steps from conceptualization to completion of a cloth article.

One general aspect includes a method of modelling a cloth article. The method of modelling also includes providing a 3D surface, the 3D surface is formed from a plurality of first points. The modelling also includes providing a virtual textile may include properties of a piece of cloth. The modelling also includes generating a flat pattern representing 2D shapes that form the 3D surface. The modelling also includes generating a cloth model to be simulated based on user interactions between the 3D surface, the virtual textile, and the flat pattern. The modelling also includes updating the 3D surface based on the user interactions. The modelling also includes simulating the cloth model. Other embodiments of this aspect include corresponding computer systems, apparatus, and computer programs recorded on one or more computer storage devices, each configured to perform the actions of the methods.

Implementations may include one or more of the following features. The method may include updating the 3D surface based on simulated behavior of the cloth model. The plurality of first points are vertices of polygons that may include the 3d surface. The properties of a piece of cloth may include a plurality of second points, each of the plurality of second points having defined relationships with one or more of the plurality of second points. Building a simulated cloth file may include creating a surface topology.

According to some features, creating a new surface topology may include: identifying one or more pieces of cloth: tessellating each of the one or more pieces of cloth with a grid structure, the grid structure may include a plurality of grid points: identifying grid points that are outside a boundary curve and adjacent to a grid point within the boundary curve; and shifting the identified grid points onto the boundary curve.

According to some features, identifying one or more pieces of cloth may include: identifying and correcting curves that are not closed: identifying and correcting curves that intersect with each other; identifying and correcting curves that self-intersect; and identifying one or more groups of curves, each group of curves forming a piece of cloth. A group of curves may include an outermost curve and one or more curves contained within the outermost curve. The boundary curve may include the outermost curve.

According to some features, tessellating each of the one or more pieces of cloth with a grid structure may include: creating a minimum enclosing grid, instantiating all grid points, and instantiating springs from a grid-space vector format. The minimum enclosing grid is a grid of n rows and m columns, where n is a height of a bounding box of a group of curves divided by a cloth resolution and rounded up to the nearest integer + 1, and m is a width of the bounding box divided by the cloth resolution and rounded up to the nearest integer + 1.

According to some features, shifting the identified grid points onto the boundary curve may include identifying one or more grid patches that may include one or more identified grid points and one or more adjacent grid points within the boundary curve, where each grid patch may include four grid points arranged in a 2 × 2 configuration.

According to some features, shifting the identified grid points onto the boundary curves further may include: identifying one or more kink points on the boundary curves, identifying grid patches that contain one or more kink points; shifting an identified grid point to the one or more kink points, where the shifted identified grid point is the identified grid point within the grid patch that is closest to the kink point.

According to some features, shifting the identified grid points onto the boundary curve further may include: identifying grid patches may include two identified grid points and two grid points inside the boundary curve, identifying the grid point inside the boundary curve that each identified grid point should be shifted to, finding an intersection between the boundary curve and a line between each identified grid point and the grid point inside the boundary curve, and shifting each of the grid points within the boundary curves to their respective intersection.

According to some features, shifting the identified grid points onto the boundary curve further may include: identifying grid patches may include three identified grid points and one grid point inside the boundary curve, discarding the identified grid point that is diagonal to the grid point inside the boundary curve, finding an intersection between the boundary curve and each line between the grid point inside the boundary curve and each identified grid point that is orthogonal to the grid point within the boundary curve, and shifting each identified grid point that is orthogonal to the grid point within the boundary curve to their respective intersection.

According to some features, shifting the identified grid points onto the boundary curve further may include: identifying grid patches may include one identified grid point and three grid points within the boundary curve, finding an intersection between the boundary curve and each line between each of the grid points inside the boundary curve, determining a distance between each of the grid points inside the boundary curve and its respective intersection, selecting the grid point inside the boundary curve with the smallest distance to its respective intersection, and shifting the identified grid point to the intersection of the selected grid point inside the boundary curve.

Additional features may include: calculating a rest length between pairs of second points having a defined relationship, writing a mesh for the 3D surface while in 2D space, identifying one or more new grid points generated, identifying a face and coordinate for each of the one or more new grid points, identifying a position on the 3D surface for each of the one or more new grid points, and attaching any new coincident boundary curve pairs.

One general aspect includes an apparatus for modelling a cloth article. The apparatus also includes a memory and a processor, the processor operably coupled to the memory. The apparatus also includes a display coupled to the processor, the processor operating one or more modules selected from the group may include a design operations module providing a 3D surface, a cloth module providing a cloth model, and a flat pattern module providing a flat pattern. The apparatus also includes where the memory stores instructions that, when executed by the processor, cause the processor to control the design operations module, cloth simulation module and pattern solver to perform the method herein. Other embodiments of this aspect include corresponding computer systems, apparatus, and computer programs recorded on one or more computer storage devices, each configured to perform the actions of the methods.

Another general aspect includes a computer readable medium having instructions stored thereon that when executed by a processor of a computer system, cause the computer system to perform that methods herein. Implementations of the described techniques may include hardware, a method or process, or computer software on a computer-accessible medium.

### BRIEF DESCRIPTION OF THE DRAWINGS

In order for the present disclosure, to be better understood and for its practical applications to be appreciated, the following Figures are provided and referenced hereafter. It should be noted that the Figures are given as examples only and in no way limit the scope of the invention.

FIG. 1A schematically illustrates a high-level diagram of a system for modelling cloth for an article, in accordance with embodiments of the present disclosure:

FIG. 1B schematically illustrates a high-level diagram of the interaction between several modules, in accordance with embodiments of the present disclosure:

FIGS. 2A to 2E are flowcharts illustrating a method for modelling a cloth article, in accordance with embodiments of the present disclosure;

FIG. 2A is a high-level workflow of a method for modelling a cloth article, in accordance with embodiments of the present disclosure;

FIGS. 2B to 2E are schematic illustrations of detailed processes of operations and steps of the method of FIG. 2A, in accordance with embodiments of the present disclosure;

FIG. 2B is a schematic illustration of a detailed process of generating a cloth model for modelling a cloth article, in accordance with some embodiments of the present disclosure;

FIG. 2C is a schematic illustration of a detailed process of identifying pieces of cloth from 2D parametrization for modelling a cloth article, in accordance with embodiments of the present disclosure;

FIG. 2D is a schematic illustration of a detailed process of tessellating cloth with grid structure for modelling a cloth article, in accordance with embodiments of the present disclosure;

FIG. 2E is a schematic illustration of a detailed process of shifting identified 2D points onto boundary curves for modelling a cloth article, in accordance with embodiments of the present disclosure:

FIG. 3A is a schematic illustration of a surface of a 3D surface of a T-shirt presented in a 2D form, and FIG. 3B is a schematic illustration of a T-shirt cloth model based on the 3D surface of FIG. 3A, in accordance with embodiments of the present disclosure;

FIG. 4A is a schematic illustration of a virtual textile, in accordance with embodiments of the present disclosure;

FIG. 4B is a schematic illustration of cloth simulation parameters of a virtual textile, and FIG. 4C is a schematic illustration of a cross-section through a bent piece of virtual textile, in accordance with embodiments of the present disclosure;

FIGS. 5A to 15B schematically illustrate various modelling tools to enable a designer to modify the article being designed on a 3D surface(s), in accordance with embodiments of the present disclosure:

FIGS. 5A and 5B are schematic illustrations of a process of modelling with a starting point of a previously produced article, in accordance with embodiments of the present disclosure;

FIGS. 6A and 6B are schematic illustrations of a process of modelling with a starting point of a blank base form, in accordance with embodiments of the present disclosure;

FIGS. 7A and 7B are schematic illustrations of a process of modelling with a starting point of a blank base form at a different angle from that in FIGS. 6A and 6B, in accordance with embodiments of the present disclosure;

FIGS. 8A to 8C are schematic illustrations of a process of mapping points of an area projected on a base form onto a virtual textile and cloth model in cloth module, in accordance with some embodiments of the present disclosure;

FIGS. 9A to 14G schematically illustrate various pin modelling tools to replicate using pins when a designer is manually designing, in accordance with embodiments of the present disclosure:

FIGS. 9A to 9C are schematic illustrations of a process of using a first pin modelling tool or a pinning tool on a simulated piece of cloth, in accordance with embodiments of the present disclosure;

FIGS. 10A to 10D are schematic illustrations of a process of using a second pin modelling tool or a pin group tool on a simulated piece of cloth, in accordance with embodiments of the present disclosure:

FIG. 11 is a schematic illustration of a third pin modelling tool or a pin line tool on simulated pieces of cloths:

FIGS. 12A to 12F are schematic illustrations of operations carried out with using a pin line tool on a top edge of a simulated cloth, in accordance with embodiments of the present disclosure;

FIGS. 13A to 13D schematically illustrate results of some scaling operations using a pin line tool on a simulated piece of cloth, in accordance with embodiment of the present disclosure:

FIGS. 14A to 14G schematically illustrate various translations of a pin line, in accordance with some embodiments of the present disclosure;

FIGS. 15A and 15B schematically illustrate a curve modelling tool that may apply curves to a 3D surface, in accordance with embodiments of the present disclosure;

FIGS. 16A to 16D schematically illustrate a cloth model, in accordance with embodiments of the present disclosure: and

FIGS. 17A to 17C schematically illustrates a process of moving a simulated line from an initial position to a folded or pleated position, in accordance with embodiments of the present disclosure.

Identical or duplicate or equivalent or similar structures, elements, or parts that appear in one or more drawings are generally labelled with the same reference numeral, optionally with an additional letter or letters to distinguish between similar entities or variants of entities and may not be repeatedly labelled and/or described. References to previously presented elements are implied without necessarily further citing the drawing or description in which they appear.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example. “processing.” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer’s registers and/or memories into other data similarly represented as physical quantities within the computer’s registers and/or memories or other information non-transitory storage medium (e.g., a memory) that may store instructions to perform operations and/or processes.

Although embodiments of the disclosure are not limited in this regard, the terms “pharality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

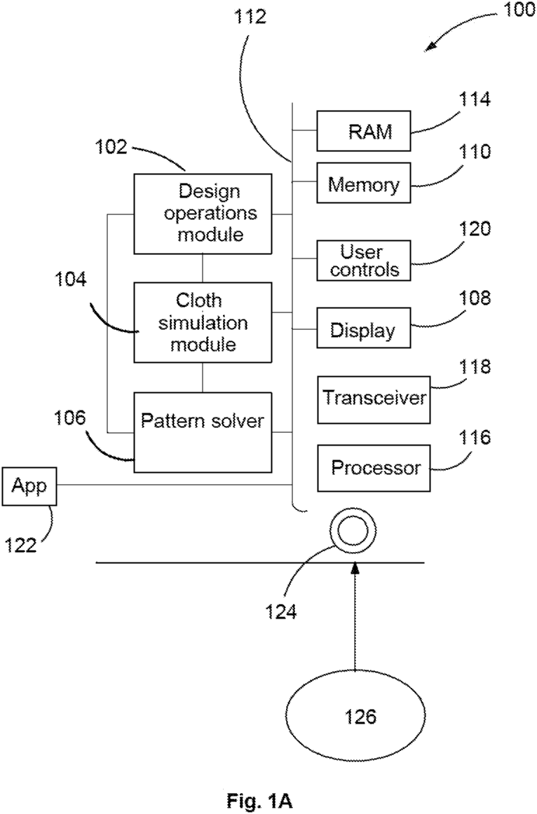

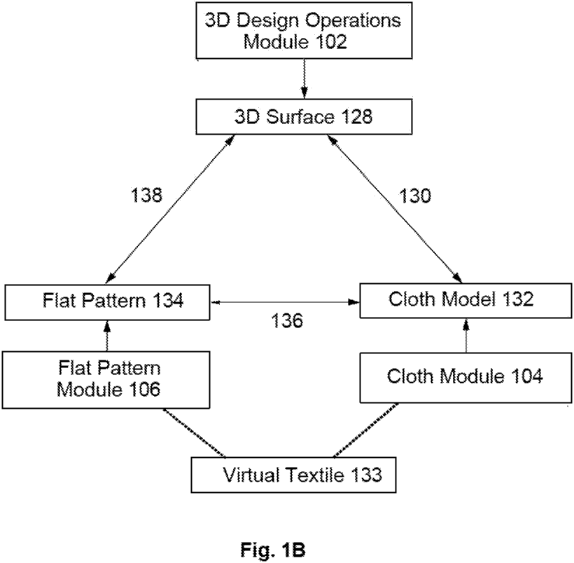

FIG. 1A schematically illustrates a high-level diagram of a system 100 for modelling cloth for an article, in accordance with embodiments of the present disclosure. Some of the methods disclosed herein may be implemented on a computer system 100 described with reference to FIG. 1A.

According to some embodiments, the methods enable a garment to be designed directly on a 3D surface, with a cloth simulation, rather than requiring creation and modification of a existing patterns. For abbreviation purposes, the terms 3D, three-dimensional, or three dimensions may also be referred to as 3D: the terms 2D, two-dimensional, or two dimensions may be referred to as 2D, the term 3D surface includes and may also refer to 3D surfaces.

According to some embodiments of the present disclosure, design modifications can automatically be carried from the 3D surface and/or cloth simulation into a flat pattern. In some embodiments, this is done in real-time. This enables the designer to see the effect of modifications made to the 3D surface on the flat pattern.

According to some embodiments of the present disclosure, in practical applications of the present methods a computer system, such as a CAD software application, can be used from initial design conception, through the design process, refinement, and production of a flat pattern or of the cloth article itself.

According to some embodiments of the present disclosure, the methods may be employed, and the computerizes system, such as system 100, may include, among various computer components, a processor 116 and one or more modules, such as a design operations module 102, a cloth module 104: a flat pattern module 106. These modules are also shown in FIG. 1B. According to some embodiments of the present disclosure, the processor 116 may be operating a module such as the design operations module 102; the cloth module 104; the flat pattern module 106.

According to some embodiments of the present disclosure, a user, such as a designer, may start the design process at any one of these modules It is the interaction between these modules that enables the designer to develop the cloth article, as the appearance, construction, and behavior of any cloth article are interdependent and are each represented by the 3D surface, flat pattern, and cloth model, and acted upon by the 3D design module, flat pattern module, and cloth module respectively. The 3D design module may be used for the appearance deign of the cloth. The flat pattern module may be used to define the construction of the cloth. The cloth module may be used to control the behavior of the cloth. According to some embodiments, the 3D surface may comprise of point and/or regions. According to some embodiments, 3D surface may comprise points and/or regions representing a 3D object. According to some embodiments, the 3D surface may be realized display 108. According to some embodiments the simulated cloth or parts thereof, may, in practice, be hidden from view but is represented in some Figures for the purpose of illustration.

According to some embodiments of the present disclosure, the computer system 100 will typically be a desktop computer, which the user may interact with. According to some embodiments of the present disclosure, system 100 may also include all or some of following components, design operations module 102; cloth module 104; pattern solver 106; a display 108; non-volatile (non-transitory) memory 110: random access memory (“RAM”) 114; one or more processing components embodied in the processor module 116; a transceiver component 118 that includes one or more transceivers; and user controls 120. According to some embodiments, the above components are electronic communication via a bus 112.

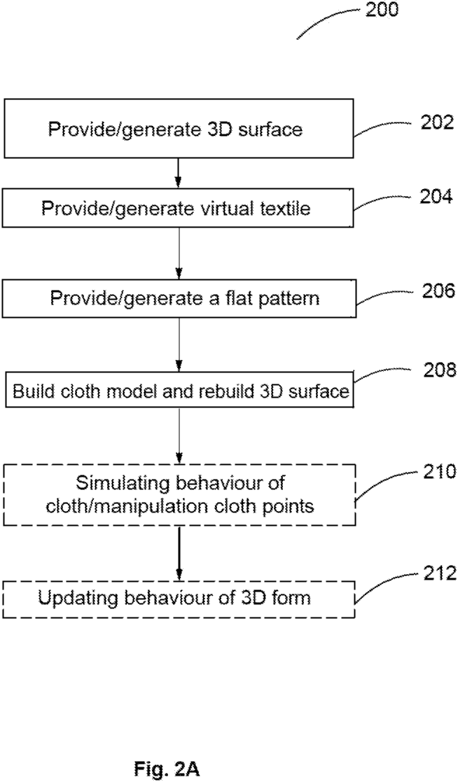

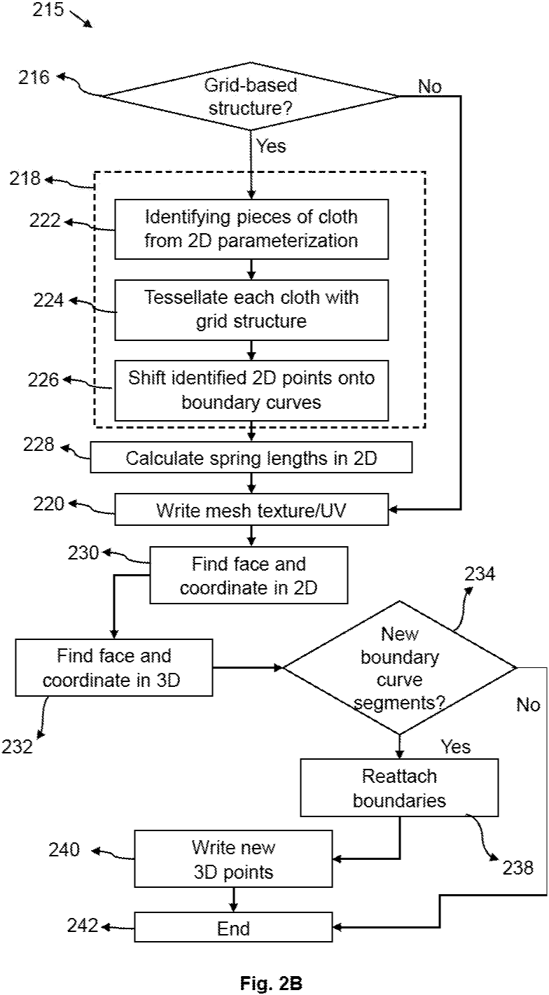

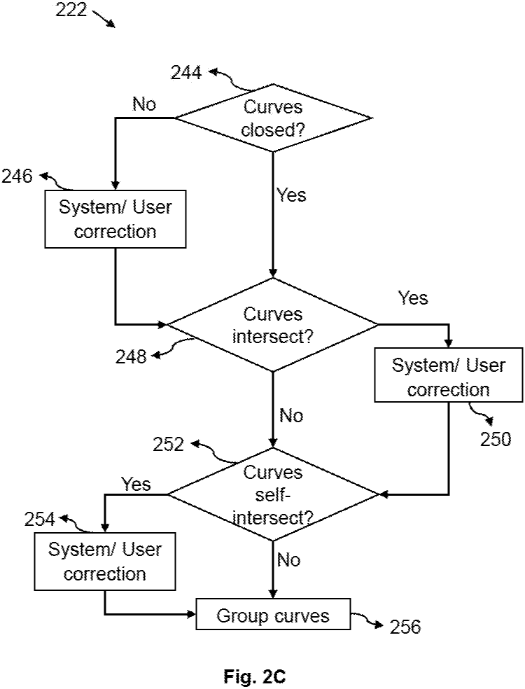

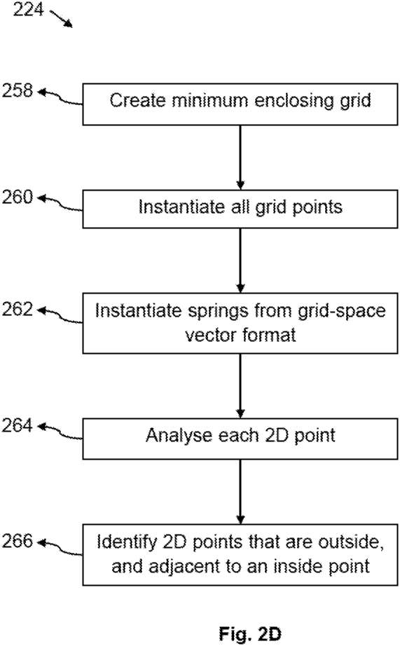

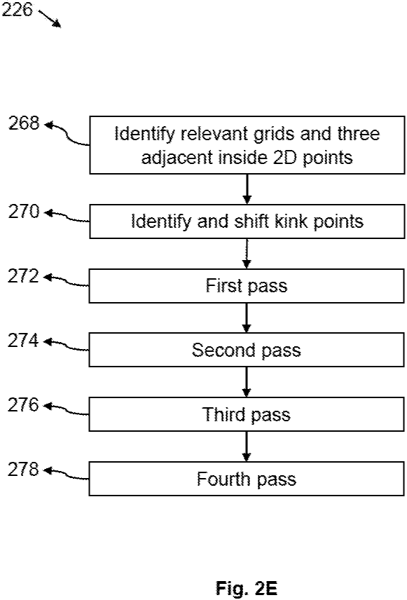

According to some embodiments, the display 108 generally operates to provide a presentation of content, such as the 3D surface. In general, the non-volatile data storage 110, also referred to as non-volatile memory, functions to store data and executable code. The executable code in this instance comprises instructions enabling the system 100 to perform the methods disclosed herein, such as that described with reference to FIGS. 2.

According to some embodiments, although it may be possible to execute the code from the non-volatile memory 110, the executable code in the non-volatile memory 110 is typically loaded into RAM 114 and executed by the processor 116. The processor 116 in connection with RAM 114 generally operate to execute the instructions stored in non-volatile memory 110.

According to some embodiments, the processor 116 may include one or more video processors. However, to display the movement of simulated cloth (which may also be referred to as the simulated piece of cloth) as it settles or moves, e.g., after modification, into a rest condition in a 3D surface it can be desirable to update the arrangement of the 3D surface between 20 and 40 times per second, and sometimes faster. Such an update rate can be difficult to achieve with a CPU, except for small articles the mesh for which is composed of few polygons. Instead, it is desirable to execute the instructions in a GPU that can run multiple process threads in parallel.

According to some embodiments, the transceiver component 118 includes one or more transceiver chains, which may be used for communicating with external devices via wireless networks. According to some embodiments, reference numeral 124 indicates that the computer system 100 may include physical buttons, as well as virtual buttons such as those that would be displayed on display 108. Moreover, the computer system 100 may communicate with other computer systems or data sources over network 126.

According to some embodiments, the computer system 100 may also include an output for outputting the flat pattern solved for by the pattern solver. That flat pattern may be displayed on display 108, produced in physical copy (e.g., printed), produced in pre-cut cloth by instructing a cutting machine to cut the cloth, or cut from cloth and assembled to form the article being designed.

It should be recognized that FIG. 1A is merely exemplary and that the functions described herein may be implemented in hardware, software, firmware, or any combination thereof. If implemented in software, the functions may be stored on, or transmitted as, one or more instructions or code encoded on a non-transitory computer-readable medium 110. According to some embodiments, the methods, described with reference to FIGS. 2A - 2E, may be stored as instructions on the computer-readable medium to await execution by a computer system. According to some embodiments of the present disclosure, a user may access the software from any one of the modules. 102, 104. 106.

According to some embodiments, the 3D design operations module 102 may be used to produce a 3D surface 128. According to some embodiments, each of the 3D surface 128 points may be mapped (per arrow 130) to a location in a simulated cloth represented by, and interchangeably referred to as, cloth model 132.

According to some embodiments, each of the 3D surface points is also mapped to a corresponding location on a flat pattern 134, which is derived from the 3D surface 128 and a virtual textile 133. According to some embodiments, the flat pattern 134 may comprise the 2D shapes which have to be cut out of a flat sheet of material, and whose segments of their boundary have to be joined in order to create the 3D shape taking into account the virtual textile 133 parameters. According to some embodiments, flat pattern 134 may comprise of one or a plurality shapes of flat patterns. According to some embodiments, the flat pattern may comprise the 2D shapes forming the article represented by the 3D surface. According to some embodiments, the flat pattern shape edges or shapes are joined together. According to some embodiments, 2D shapes may be created by 2D parameterization methods including Angle Based Flattening, Least Squares Conformal Map, etc.

According to some embodiments, virtual textile 133 comprises surface appearance and behavior data of the piece of material to be simulated. Appearance data may comprise appearance maps. Appearance maps may comprise texture maps, normal maps, height maps and the like. Appearance data may further comprise limits on possible sizes and changes, if and when such limits are applied to simulated piece of material. According to some embodiments, the behavior data comprises bending and stiffness parameters of a cloth material to be simulated. Bending and stiffness data may comprise data relating to bending or stiffness of warp or weft.

Thus, in accordance with some embodiments, each point of the 3D surface 128 is mapped to a corresponding location in the flat pattern 134 (per arrow 138). Since points of the 3D surface 128 are mapped to both the flat pattern 134, and cloth model 132, the cloth parameters comprise parameters from the virtual textile 133 that are imported into cloth model 132, for example, per arrow 136. The cloth module 104 may then run the simulation of the cloth model 132 and may determine the behavior of the 3D surface 128 in response to operations performed thereon or on the cloth model 132 given parameters provided by the flat pattern 134.

According to some embodiments, the user may initiate the design environment through the flat pattern module 106. The designer may import a flat pattern 134 into the flat pattern module 106, select from a suite of existing flat patterns 134 or shapes, or may draw a new flat pattern 134. The 3D design operations module 102 may then assemble the flat pattern shape or shapes into a 3D surface 128 and the same mapping and cloth parameter relationships can be established. The cloth module 104 may also build and simulate a cloth model 132 based on the flat patterns 134 or shapes.

According to some embodiments, the designer may initiate the design environment through the cloth module 104, by selecting or defining cloth parameters or a particular cloth. This determines which virtual textile 133 to use and the 3D design operations module 102 may be then employed to define the 3D surface 128 being designed, or the flat pattern module 106 can be used to select or draw shapes from which the 3D surface 128 can be constructed. Cloth module 104 may also allow manipulation of the cloth by allowing a user to change the cloth parameters or constraints.

According to some embodiments, some of the functionality of the design operations module 102, cloth module 104 and flat pattern module 106 will be described in the context of the method 200 illustrated in FIGS. 2A to 2E. The method 200 is for modelling a cloth article, that is enabling the designer to derive the cloth article’s appearance, construction, and behavior based on a 3D surface and the material from which the 3D surface is to be constructed. According to some embodiments, the method 200 illustrated in FIGS. 2A to 2E may be used in connection with various computing devices that are suitable to obtain and realize the results and objectives of the present disclosure.

FIGS. 2A to 2E are flowcharts illustrating a method 200 for modelling a cloth article, in accordance with embodiments of the present disclosure. FIG. 2A is a high-level workflow of a method 200 for modelling a cloth article, in accordance with embodiments of the present disclosure. FIGS. 2B to 2E are schematic illustrations of detailed processes of operations and steps of the method of FIG. 2A, in accordance with embodiments of the present disclosure.

Method 200 may commence at operation 202 which may comprise providing or generating at least one 3D surface 128, such as points and/or regions forming a surface, by the 3D design operations module 102. In some embodiments of the disclosure, the points or regions are provided in the form a computerized file. According to some embodiments, the points or regions are provided or generated as data representing 3D surface. Reference to regions in the present disclosure also refers to faces or polygons and vice versa.

According to some embodiments, the 3D surface 128 may be discrete. Alternatively, the 3D surface 128 may be non-uniform rational basis spline (NURBS) or parametric. In some embodiments, 3D Surface 128 which is parametric or NURBS is converted to a discrete surface. A discrete surface is preferred as it can carry texture (or UV) information, which is important for cloth-based products. A discrete surface is also preferred as a discrete representation of the surface provides many reference points to track the mapping between the 3D and 2D space, as points will need to be mapped back and forth in subsequent operations.

According to some embodiments, method 200 may continue with operation 204 which comprises providing or generating the virtual textile 133. The virtual textile 133 may be generated or provided in the format of a file. According to some embodiments, method 200 may continue with operation 206 which comprises providing or generating the flat pattern 134 by flat pattern module 106. The flat pattern 134 may be generated or provided in the format of a file.

The description below will generally refer to a single 3D surface 128. However, it will be appreciated that the same teachings apply when there is more than one 3D surface 128. Moreover, operations performed on a 3D surface 128 may not be performed on all 3D surfaces 128 in the article. Conversely, some operations may be performed concurrently on more than one 3D surface 128.

According to some embodiments, method 200 may optionally comprise using cloth model 132 in conjunction with cloth module 104 to simulate a behavior of the piece of cloth in operation 210. The simulated behavior will usually be the movement of the piece of cloth, which will be taken to include the whole of the piece of cloth, or one or more regions of the piece of cloth, with movement - e.g., rotation or translation - of constrained points in the cloth model 132, or a response of the cloth to operations performed on the 3D surface - e.g., adding cloth to the 3D surface or cutting cloth away and updating the cloth model 132 as the addition, deletion, or rewriting of points and springs.

According to some embodiments, where an operation is performed on the 3D surface that affects the cloth model, the method may further include updating the 3D surface based on the simulated behavior in operation 212. Thus, the behavior of the 3D surface changes depending on how the 3D surface is constructed - e.g., the shapes from which it is made, how those shapes are assembled and how they relate to the virtual textile.

FIG. 2B is a schematic illustration of a detailed process of generating a cloth model for modelling a cloth article, in accordance with some embodiments of the present disclosure. According to some embodiments, the detailed process is of operation 208 of method 200, designated method 215. According to some embodiments of the present disclosure, operation 216 may comprise determining whether a grid-based structure should be used. According to some embodiments a grid-based structure is a file structure where each point has a row and column in a grid formation in addition to its 2D position. For non-woven or non-knitted material such as leather or felt, any regular structure may be used. A grid-based structure may also be used for such materials. For cloth materials, the structure is preferably represented using a grid structure to model accurate cloth behavior. A grid structure is preferred because most cloth or apparel is either woven or knitted, and thus there is the notion of a 2D surface with vertical and horizontal axes with their respective stretch and bending stiffness properties. For knitted cloth, there may be a sub-structure, or tessellation unit, for each point on the grid structure with the tessellation using the sub-unit being on the grid structure.

According to some embodiments, if a grid-based structure is not used, tessellation would be performed to obtain a certain form (not shown) and the method 215 continues to operation 220 which may comprise writing a mesh texture or UV in 2D space. In other embodiments, if a grid-based structure is used, method 215 continues to operation 218 which may comprise creating a new surface topology in 2D. Such surface topology describes discrete positions on the surface as well as the connections between the discrete positions. According to some embodiments, operation 218 may comprise generating a new surface topology according to operations 222, 224. 226. According to some embodiments, operation 222 may comprise checking and processing the boundary curves generated during 2D parameterization on the flat pattern 134 carried out in operation 206 to identify that the curves generated during the 2D parameterization form individual pieces of cloth. According to some embodiments, in some cases, if a new virtual textile 133 or if a flat pattern 134 is translated, rotated or scaled, operation 222 will not be performed.

According to some embodiments, operation 224 may comprise of tessellating each piece of cloth with the grid-based structure. 2D points that are outside the area defined by the boundary curves and adjacent to a 2D point inside the boundary curves are identified. 2D points that are outside may be defined as being outside the one boundary curve, or, in the case of a group of curves, either outside the largest enclosing boundary curve or inside a cut-out area defined by a smaller inset boundary curve. A 2D point that is inside may be defined as being inside the one boundary curve, or inside the area defined by the group of curves, i.e. inside the largest enclosing boundary curve, and not in the cut-out area defined by a smaller inset boundary curves.

According to some embodiments, operation 226 may comprise shifting the identified 2D points that are outside the area defined by the boundary curves onto the boundary curves. The boundary curves may be those identified in operation 222.

According to some embodiments, once the identified 2D points are shifted to boundary curves of operation 226 within operation 218 is completed. According to some embodiments operation 228 may comprise calculating each cloth model 132 spring’s original lengths, or rest lengths, between 2D points while in 2D space. According to some embodiments, the structure of springs may be defined as (M, N), with M being the number of grid points on the x-axis (or column), and N being the number of grid points on the y-axis (or row) between a first end of the spring and a second end of the spring.

According to some embodiments, the operation 228 calculation is performed when the points of the cloth model 132 are in 2D space, instantiated on the flat pattern 134, as the flat pattern 134 represents the piece of cloth laid flat, at rest and at its initial condition, and is effectively a continuous surface, thus increasing accuracy. It will be appreciated that once a surface for which the operation 228 has been performed is transformed back into 3D space, it is discretized and would only be an approximation.

According to some embodiments, operation 220 may comprise writing the mesh’s UV or texture when the cloth model 132 is in 2D space. As the cloth object is necessarily cut out of flat sheets of material and then assembled, therefore the appearance of its surface (i.e., “texture”) would be from 2D. UV coordinates are 2D, so the position of each 2D point is also its UV coordinate.

According to some embodiments, operation 230 may comprise determining where the 2D-parameterized face and coordinate of the new 2D point is. Each 2D-parameterized vertex comprises an original 3D position that forms the 3D surface. The new 2D point’s coordinate on a 2D-parameterized face, composed of three 2D-parameterized vertices, is the same as the new 3D point’s coordinate on the 3D face, composed of the three original 3D positions, on the 3D surface. By using the new 2D point’s coordinate on the 2D-parameterized face, the new 3D point’s position is calculated from the original 3D face. In some embodiments, the 2D point is not saved. This is carried out by looping through the faces (or simply triangles) of the 2D parameterization of the initial 3D surface 128 and carrying out a min-max test between the 2D point and the bounds of the face/triangle. According to some embodiments, faces are discrete pieces which make up the 3D surface 128, defined by three or more vertices. For every new 2D point is inside a 2D-parameterized triangle, the system records the index of that triangle and finds the new 2D point’s barycentric coordinate within it. The triangle is a face/discrete piece/unit of the surface defined by three vertices.

According to some embodiments, operation 232 may comprise, uses the information obtained in operation 230. mapping the new 2D points onto the 3D surface 128. This is possible because the 2D parameterized triangle is equivalent to the triangle in the initial 3D surface. For each new 2D point, the system (through one of the processing instances used by the various modules) brings up the triangle from the 3D surface data using the logged triangle index and the three 3D vertices that form the triangle. The system then uses the logged barycentric coordinate of the new 2D point to calculate its 3D position from the three 3D vertices.

According to some embodiments, operation 234 may comprise of determining if new boundary curve segments that were not present in the initial 3D surface were generated in operations 222 to 226. These are edges that were coincident in the initial 3D surface but are not coincident in the 2D parameterization after operations 222 to 226. According to some embodiments of the disclosure, edges are the sides of the triangles (or other polygon) as defined by the triangle/face/poly data in the discrete 3D surface 128 representation, where if a triangle is composed of points A, B, and C, an edge is the straight line between two points, and so there are three edges, one between A and B, one between B and C, and one between C and A. As the flat pattern 134 comprises the boundary of the 2D parameterization, the system locates the boundary of the 2D parameterization by identifying, in the 2D parameterized triangles/polygons, edges that are not coincident with another edge, and then putting such edges in order such that an edge’s second point is the next edge’s first point. A chain of such ordered, continuous edges, making up a closed curve such that the second point of the last edge in the chain is the same as the first point of the first edge in the chain, a closed curve, is a curve that makes up a flat pattern.

According to some embodiments, no new boundary curve segments were created in operations 222 to 226, a cloth model generation is completed. According to some embodiments, if new boundary curve segments were generated during operations 222 to 226, operation 238 is executed and may comprise reattaching the new boundary curve segments in 3D space in the cloth model 132. This is because, although the new boundary curve segments will be coincident again when mapped from 2D space back into 3D space, the new boundary curve segments will detach from each other when the cloth simulation starts to run. Therefore, in accordance with some embodiments, the operation of reattaching boundaries may comprise creating springs with a rest length of zero between the points on those coincident boundary segments. Such length zero springs result in attached boundaries being connected when cloth-simulated and rendered. In accordance with some embodiments, because of the way the new grid-based points were generated and fitted to the boundary curves, coincident boundary curve segment pairs may neither have the same number of points on them, nor have points distributed along said pairs evenly such that points on either boundary curve segment are paired. It may appreciated that although there may be differing number and arrangement of points, coincident boundary curve segment pairs need not have the same number of points, as long as each point on the boundary curve segment with fewer points is coincident with one point on its partner boundary curve segment.

According to some embodiments, operation 240 may comprise rewriting the new 3D points to mesh and cloth model 132. In accordance with some embodiments, operation 242 may represent a termination of method 215 and continue of processing with operation 210.

FIG. 2C is a schematic illustration of a detailed process of identifying pieces of cloth from 2D parametrization 222 for modelling a cloth article, in accordance with embodiments of the present disclosure. According to some embodiments, operation 244 may comprise determining if curves generated during 2D parameterization are closed. According to some embodiments of the disclosure, a closed curve is one whose last point is equal to its first point. If a curve is identified as not closed, according to some embodiments, operation 246 may comprise correcting the curves by closing the open curves. According to some embodiments, the closing and opening of a curve is performed by the system adding some number of points to the ned of the curve such that the last point is equal to its first point. In accordance with some embodiments, the closing of the curves is performed automatically by the system. In accordance with some embodiments, the closing of the curves is performed manually by a user. In accordance with other embodiments, the system may delete the curve, ignore the curve, prompt a user to approve of a deletion of the curve, or prompt a user to close the curve by highlighting the curve or requesting for the approval of the result of an automatic curve closing function.

According to some embodiments, operation 248, may comprise determining whether any curves intersect one another. This is carried out by obtaining the bounding box of each curve and performing axis-aligned bounding boxes (AABB) tests between any two curves. In some alternative embodiments, the bounding box of each curve and (AABB) tests between pairs of the curves that don’t intersect. For pairs of curves that fail the AABB test, the pairs of line segments from each curve are compared to determine if the curves intersect one another. If the compared curves are determined to intersect one another in operation 248, in accordance with some embodiments, operation 246 may comprise correcting the curves by discarding the disruptive curves. In accordance with some embodiments, the correction of operation 254 is performed automatically by the system. In accordance with some embodiments, corrections may include repositioning curves such that the curves do not intersect, or by re-drawing curve segments. Corrections may be done automatically or manually.

According to some embodiments, in step 252, the system may then check that the curves do not self-intersect. This is carried out by testing all pairs of line segments that make up the curve. If the system identifies self-intersecting curves, the system may continue with step 254 by asking the user to correct the self-intersecting curves. User corrections may include re-drawing curve segments or approving the segmentation of the self-intersecting curve into multiple non-self-intersecting curves at the intersection points. Once the corrections are complete in step 254, the system may continue to step 256. If the system determines in step 252 that there are no self-intersecting curves, the system may directly continue to step 256.

According to some embodiments, operation 256 may comprise grouping the curves by identifying curves that fully contain other smaller curves. Such curves are identified by finding the bounding boxes of each curve and conducting AABB tests. According to some embodiments, each group of curves should have one outermost curve that fully contain any number of smaller curves. According to some embodiments, each group of curves is one piece of cloth, where the outmost curve is a boundary curve that defines the boundary of the cloth piece, and the smaller internal curves define the cut-out areas of the cloth piece.

FIG. 2D is a schematic illustration of a detailed process of tessellating cloth with grid structure 224 for modelling a cloth article, in accordance with embodiments of the present disclosure. According to some embodiments, operation 258 may comprise creating a minimum enclosing grid. Using the bounding box of each curve group from operation 256, and the cloth resolution of the selected material that is to be represented by the piece from the virtual textile 133, a minimum grid of N rows and M columns is generated, where N is the height of the bounding box divided by the cloth resolution, rounded up to the nearest integer (ceiling) plus one, and M is the width of the bounding box divided by the cloth resolution, then rounded up to the nearest integer (ceiling) plus one. The grid of height (N-1) * cloth resolution and width (M-1) * cloth resolution may then be centered around the bounding box. In accordance with some embodiments, a minimum point of the grid may be determined by taking the difference in extent of the bounding box and grid, then subtracting that from the minimum of the bounding box.

According to some embodiments, operation 260 may comprise instantiating all the grid points by sequentially advancing by row and column on the grid and calculating the 2D position of the grid point by adding the cloth resolution * column index and cloth resolution * row index to the minimum point of the grid. The grid points outside the boundary curves may be discarded subsequently, after writing the springs (distance constraints) between them for the cloth simulation.

According to some embodiments, operation 262 may comprise instantiating the springs from their grid-space vector format when all the 2D grid points are present. For example, there might be two types of structural springs, defined in (m, n) as (1. 0) and (0,1), and two shear springs (1,1) and (-1, -1), and any number of flexion or bend springs, such as (2, 0), or (-3, -3), etc. The system may iterate through the grid points via their grid-position, through the M columns and N rows, and for each point and, if there is also a point (m, n) away within the bounds of the grid, instantiate a spring to a list or array to be to be written to the cloth model 132. Each spring is relative in that it contains a reference to point A, and to point B, but not their absolute positions. For example, in the simplest 2 × 2 grid, for the spring of type (1, 0), two of those springs will be instantiated: one between the point at grid position (0. 0) and the point at grid position (1. 0), and one between the point at grid position (0, 1) and the point at grid position (1, 1).

According to some embodiments, operation 264 may comprise analyzing each 2D point in the grid formation to identify if each 2D point is inside or outside the group of curves. This is carried out by casting a ray in one direction (e.g., down (0, -1)) from each 2D point and checking for intersections between this line and each line segment of the group of curves. If there is an odd number of intersections, the 2D point is identified as inside. If there is an even number of intersections, the 2D point is identified as outside. In accordance with some embodiments, 2D points that lie exactly on the boundary curve are treated as being inside. The identities may be recorded as Boolean values.

According to some embodiments, operation 266 may comprise identifying the 2D points that are outside, and adjacent to an inside point. In accordance with some embodiments, these 2D points will be shifted onto the curve edge or boundary in step 226. In accordance with some embodiments, such shifting may be performed by iterating through the springs of stride one, i.e. (1, 0), (0, 1), (1, 1), (-1, -1) and checking the identity of the points.

FIG. 2E is a schematic illustration of a detailed process of shifting identified 2D points onto boundary curves 226 for modelling a cloth article, in accordance with embodiments of the present disclosure. Step 226 shifts 2D points identified in association with step 266 onto the boundary curves to preserve the grid-based structure and the integrity of the directional springs as much as possible. The 2D points may be shifted onto the boundary curve either horizontally, vertically, or diagonally, i.e.. along the axes or springs that connect it to adjacent 2D points in the grid which are inside the boundary curves. The decision to shift a point horizontally, vertically, or diagonally is based on the intersection point of the intersecting boundary curve segment in relation to the three adjacent 2D points within the relevant 2×2 grid patch within the entire grid. In some embodiments, the process of shifting requires re-writing the 2D points information into the relevant file, such as the cloth model 132 or flat pattern 134.

According to some embodiments, operation 268 may comprise identifying the relevant grids and three adjacent inside 2D points. In accordance with some embodiments, all the 2×2 grid patches that contain 2D points to be shifted and the adjacent inside 2D points are identified so these could be shifted onto the boundary. This is done by iterating through the grid and logging all grids whose four 2D points are not all inside or not all outside the boundary curves.

According to some embodiments, operation 270 may comprise identifying any kink points on the boundary curves. In accordance with some embodiments, kink points may be any points at which the previous and next edge form an angle of less than 150 degrees. Preferably, these kink points are shifted first. Kink points are identified by comparing the direction of each segment or edge of the curve with the next one using the dot or scalar product. The kink points are then recorded.

According to some embodiments, operation 272 may comprise conducting a first pass by shifting 2D points to the kink points on the boundary curves. For each kink point, the grid patch that contains the kink point is identified by going through the list of relevant grid patches and checking its bounds with the kink point. Then, if the grid patch contains more than one outside 2D point, the outside 2D point that is closest to the kink point is identified and is then shifted to the position of the kink point.

According to some embodiments, operation 274 may comprise conducting a second pass for grid patches where two 2D points are outside, and two are inside. For each of the two outside 2D points, the system identifies the inside 2D point it should be shifted towards. The system then finds the intersection between the boundary curve and the line between the outside 2D point and the inside 2D point it should be shifted towards. The outside 2D point is then shifted to the intersection.

According to some embodiments, operation 276 may comprise conducting a third pass for grid patches where three 2D points are outside, and one is inside. In such a scenario, the two outside 2D points that are orthogonal to the inside 2D point will be shifted, and the outside 2D point that is diagonal to the inside 2D points will be discarded as it will be redundant. For the two orthogonal outside 2D points, the intersection between the boundary curve and the line between the outside 2D point and the inside 2D point is identified. The outside 2D point is then shifted to the intersection.

According to some embodiments, operation 278 may comprise conducting a fourth pass for grid patches where one 2D point is outside, and three are inside. For each of the three inside 2D points, the intersection between the boundary curve and line between it and the one outside 2D point is identified. The distance between the inside 2D point and its respective intersection is also identified. The inside 2D point with the smallest distance to the intersection is the one that the outside 2D point will shift towards. The outside 2D point is shifted to this point’s intersection.

According to some embodiments, any 2D points that remain outside the boundary curve after the four passes in operations 272, 274, 276, 278 are ignored or discarded. According to some embodiments, springs that are not between two inside 2D points are also ignored, discarded or deleted.

According to some embodiments, at least one 3D surface 128 may be provided by the design operations module 102 in operation 202 and may be displayed on display 108 to a user. Providing the at least one 3D surface 128 may involve receiving at the design operations module 102 a surface file corresponding to the surface or surfaces to be displayed. In other embodiments, the surface file may be a mesh file or a NURBS file specifying how to create the surface. In some embodiments, the 3D design operations module 102 generates the at least one 3D surface 128 - e.g., by processing a file or processing a flat pattern 134 to determine the appearance of the 3D surface 128 (per arrow 138). The article may be produced and modified on the at least one 3D surface 128. The design operations module 102 also provides a suite of modelling tools each of which performs some operation on the at least one 3D surface 128, to design the article.

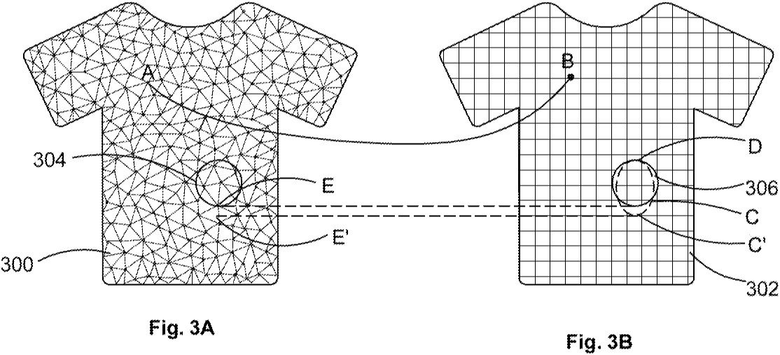

According to some embodiments, each 3D surface 128 may be a mesh of polygons (i.e., faces) each defined by a plurality of vertices (see e.g., FIG. 3A), each vertex defining a mesh point. In other embodiments, one or more of the 3D surfaces 128 may comprise a NURBS surface, other some other surface representation, or a combination of surface representations.

In some of the examples that follow, the description has been made with reference to the surface being a “mesh”, formed from vertices and polygons. In view of the present teachings, the skilled person will appreciate that other surface representations, or a combination of surface representations, may be used or may be suitable for a particular application. Moreover, the manner in which to substitute those surface representations into the present examples in place of the mesh will be apparent to the skilled person. In a mesh example, the polygons may take any shape, for example a square or rectangle. In the examples shown in the drawings, the polygons are each a triangle. Triangular polygons are particularly good at representing complex shapes. The polygons in a 3D surface may have common size or may vary in size.

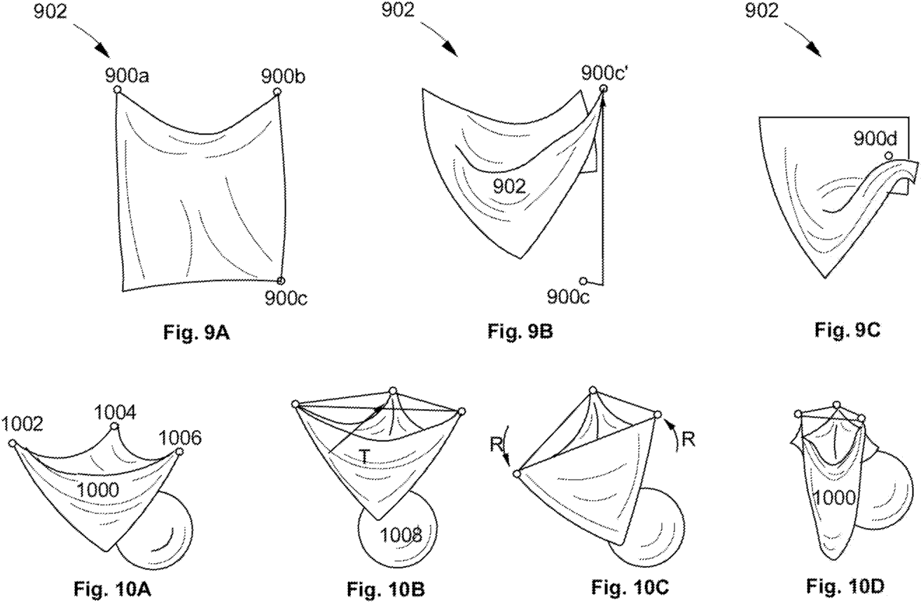

According to some embodiments, 3D surface 128 will cover a base form - e.g., base form 600 of FIGS. 6 - for which the article represented by the 3D surface 128 is being designed. For example, the base form may be in the shape of a person or object for which the article, being clothing or a cover respectively, is being designed. In other embodiments, there is no base form. For example, a 3D surface 128 may be created independently of any base form and operations can be performed on that 3D surface 128 (see e.g., FIG. 9c). In some embodiments, the 3D surface 128 or 3D surfaces 128 may cover portions of (or the entirety of) the base form. The 3D surface may include one or more areas, each area corresponding to a piece of cloth in the article. For each area corresponding to a piece of cloth in the article, each point may be mapped to a location on a corresponding cloth model 132 in the cloth module 104. per operation 210 (or arrow 136). For example, FIG. 3A is a schematic illustration of a surface 300 of a 3D surface 128 of a T-shirt presented in a 2D form, and FIG. 3B is a schematic illustration of a T-shirt cloth model 302 based on 3D surface 300 of FIG. 3A, in accordance with embodiments of the present disclosure. Surface 300 is an example of a 3D surface 128 presented in 2D form, while T-shirt cloth model 302 is an example of a cloth model 132. As illustrated in FIGS. 3A and 3B, a point A on surface 300 in FIG. 3A may map onto location B on cloth model 302 in FIG. 3B (per arrow 130 and operation 210). There may be more than one piece or type of cloth simulated by the cloth module 104, each piece or type corresponding to a different area in the 3D surface 128.

According to some embodiments, the shape of a surface may be extracted from a file comprising a previously created surface, e.g.. the T-shirt mesh 300 of FIG. 3A may be stored in, and extracted from, memory 110. In other embodiments, the shape of a surface may be built by the designer, or the designer may customize a previously created surface by applying desired dimensions to it, or by supplying the dimensions of the intended wearer or object (base form) for whom the article is being designed. The system will then construct each surface just larger than the base form to avoid spatial conflict between the created surface and base form. In other embodiments, the surface may be derived from an existing flat pattern 134 that includes edge associations defining which edges of each piece of the flat pattern 134 are connected in the assembled article (per arrow 138).

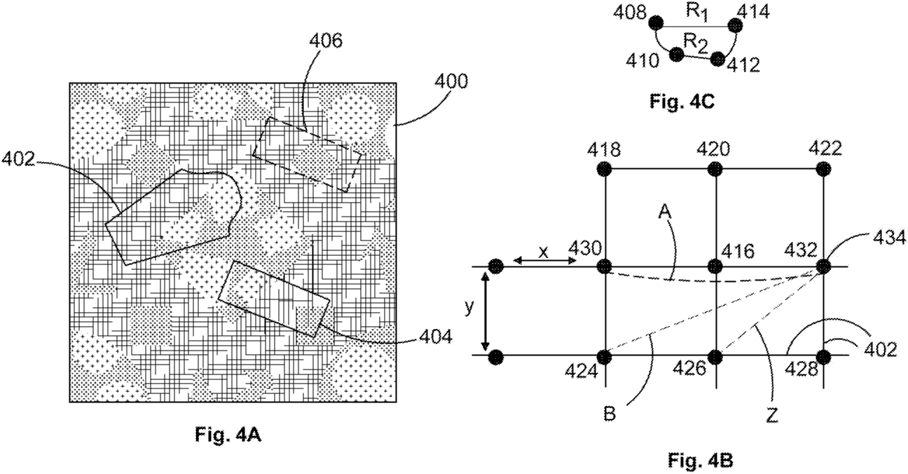

FIG. 4A is a schematic illustration of a virtual textile 400, in accordance with embodiments of the present disclosure. A virtual textile 400 is a data container for properties of the simulated piece of cloth. The other components of the system - e.g., cloth module 104 and flat pattern module 106 - extract, receive or otherwise use information from the virtual textile 400 to determine the appearance and simulated behavior of the article being designed.

According to some embodiments, virtual textile 400 may itself be stored in memory 110. In other embodiments, though the virtual textile 400 is illustrated and described herein as separate from the cloth module 104 and flat pattern module 106 for simplicity, the information relevant to each of the cloth module 104 and flat pattern module 106 may in fact be stored in the respective modules.

According to some embodiments, virtual textile 400 stores one or more appearance maps, each appearance map defining a surface appearance of the surface, each surface appearance resulting from one or more appearance properties applied across a face of a surface. An appearance map may be, for example, a texture map, normal map, or height map. These define what the article will look like from different angles - e.g., if a photograph were taken of the article from a particular angle, the appearance map or maps will define what the article in that photograph will look like.

According to some embodiments, the designer (e.g., the user of the computer system 100) may be able to view the flat pattern 134 pieces or shapes on a texture map of a virtual textile 400. The texture map provides information about the appearance of the cloth - e.g., color, patterns, and potentially other visual qualities. When the flat pattern module 106 determines the shapes of cloth pieces required to form the article, those shapes 402 and 404 are applied to the texture map to determine the appearance of the cloth pieces generated using shapes 402 and 404 on the respective 3D surface 128. The 3D surface 128 is then rendered with the surface appearance of the regions of the texture map defined by the pieces of cloth defined with shapes 402 and 404.

The term “applying” when used in relation to the flat pattern 134 or shape(s) being applied to the textile or appearance maps, may refer to overlaying the flat pattern 134 or shape(s) of the flat pattern 134 on a piece of virtual textile 400 to identify corresponding portions of the appearance maps, and carrying the relevant appearance map features into the 3D surface 128 (direct application), or determining, based on the flat pattern 134, how the points of the 3D surface 128 are mapped to the textile and then applying the corresponding portions of the appearance maps to the 3D surface 128.

According to some embodiments, for each shape of the flat pattern 134 on the virtual textile 400. the height map defines the height at each point on the shape. For example, the undulating surface of a cloth such as corduroy should not be represented as a cloth of consistent height since this would provide an unrealistic rendering of the virtual textile 400 on the 3D surface 128. Similarly, the normal map defines the surface normal at each point on the shape. Any part of the shape the surface normal of which does not extend towards the viewpoint of the designer - i.e.. in the direction the article is being viewed - or extends through a non-transparent surface, will not be displayed. These parts of the article would, in practice, be hidden behind the base form or some other part of the article.

According to some embodiments, the designer may move or reorient a shape 402 or 404 of the flat pattern 134 on the texture map, thereby changing the appearance of the shape on the 3D surface 128. For example, shape 404 may be relocated to position 406, which has a different appearance and will therefore look different when rendered on the 3D surface 128.

FIG. 4B is a schematic illustration of cloth simulation parameters of virtual textile 400. and FIG. 4C is a schematic illustration of a cross-section through a bent piece of virtual textile 400, in accordance with embodiments of the present disclosure. Virtual textile 400 stores one or more, and generally several, cloth simulation parameters. For illustration purposes, the embodiments described herein will have multiple cloth simulation parameters though in other embodiments a single cloth simulation parameter may apply uniformly across the cloth and be sufficient to model realistic behavior of the cloth. The cloth simulation parameters replicate the parameters, such as elasticity, of a real-world version of that cloth. These properties may change depending on the type of cloth being modelled.

According to some embodiments, the cloth simulation parameters will generally include elastic deformation parameters. Elastic deformation parameters parameterize the ability of the cloth to elastically deform - i.e., deform without damage to the cloth such as overstretching. Each elastic deformation parameter defines a bending, buckling, crumpling, stretching or other property of the virtual textile 400 which would affect cloth model 132. For example, virtual textile 400 may comprise cloth points 416, 418, 420, 422, 424, 426, 428, 460, and 432 illustrated as black dots on FIG. 4B and each elastic deformation parameter defines a relationship between two or more cloth points. In some embodiments, the elastic deformation parameters may be similar to springs connecting the cloth points to form a grid, as they define the resilience of the cloth between two points.

According to some embodiments, virtual textile 400 in FIGS. 4B and 4C may correspond to a piece of woven cloth having a rectangular grid of cloth points, although other arrangements of cloth points may be possible depending on the type of cloth. In some embodiments, the rectangular grid may comprise points lying along warp and (perpendicular) weft yarns. The relationship defined by each elastic deformation parameter may be between neighboring cloth points or non-neighboring cloth points. When considering a cloth as a grid of intersections between warp and weft yarns, for any particular point the neighboring points are the next points along any particular yarn, or the points on the bias that can be reached without crossing over a yarn. For example, in virtual textile 400, for point 416 the neighboring points are points 418, 420, 422, 424, 426. 428. 430 and 432. All other points in virtual textile 400 are non-neighboring points to point 416. In another example, in virtual textile 400. for point 434, the neighboring points are 416, 420, 422, 426 and 428, while the non-neighboring points are 418, 424 and 430. Moreover, for each cloth point within virtual textile 400, the neighboring points and non-neighboring points may be defined by corresponding elastic deformation parameters.

Referring to FIG. 4C, there may be an elastic deformation parameter defining a relationship R1 between cloth points 408 and 414. A real cloth will not include any component lying along R1, yet the real cloth has specific properties that apply between points 408 and 414. By contrast, R2 lies in the cloth so the properties of the cloth between points 410 and 412 may more readily correlate to the particular elastic deformation parameter represented by R2. Therefore, in some embodiments, it may be useful to separate cloth module 104 from design operations module 102 such that cloth module 104 may simulate the cloth using relationships between points that may otherwise violate a local minimum.

According to some embodiments, the elastic deformation parameters are specific to the type of cloth being simulated and greatly influence the behavior of the cloth model 132. Some elastic deformation parameters operate in a similar manner to a spring constant, defining the resistance of the cloth to stretching between two cloth points. Other cloth parameters limit the amount to which cloth points can be translated relative to other cloth points.

According to some embodiments, elastic deformation parameters may be directional for certain types of textiles such that the elastic deformation parameters in the vertical direction X may differ from those of the horizontal direction Y. Optionally, the elastic deformation parameters for the cloth when pulled on the bias (shear parameters) - i.e.. diagonally with respect to the x and y directions of FIG. 4B - may differ from the elastic deformation parameters applied in the x and y directions. Still further elastic deformation parameters may be specified such elastic as A and B between non-neighboring cloth points.

According to some embodiments, some cloths may have substantially uniform elasticity in all directions or may have greater elasticity in a particular direction than perpendicular to that direction. Such cloths may be considered as an infinite number of cloth points, joined by yarns of the relevant elasticity.

According to some embodiments, changes in behavior of the cloth due to, for example, changes in elasticity may automatically be carried into the relevant 3D surface 128 or 3D surfaces 128. Elasticity may change if there are changes in the locations in the virtual textile 400 to which flat patterns 134 are placed and vertices of the mesh of 3D surface 128 are mapped.

According to some embodiments, the virtual textile 400 may also include cloth parameters that define stretch states of the cloth. These stretch states may include a rest length, a minimum length, and a maximum length, can flexibly obtain - i.e., without folding. The maximum length is the maximum length to which the cloth can stretch between two points.

Referring to FIGS. 3A, 3B and 4A to 4C, cloth module 104 may run a simulation on the cloth model 132 or T-shirt cloth model 302 and allow manipulation of the cloth model 132 or T-shirt cloth model 302. The cloth module 104 determines a response of the cloth model 132 or T-shirt cloth model 302, and thus of each 3D surface 128, to various operations - e.g.. cutting, adding pleats and embellishments and so forth.

According to some embodiments, the cloth module 104 receives the cloth parameters from the virtual textile 400 (see FIGS. 4A to 4C). This is achieved by applying the flat pattern 134 to the virtual textile 400. The term “applying” when used in relation to the flat pattern 134 or shape(s) of the flat pattern 134 being applied to the virtual textile 400, can refer to overlaying the flat pattern 134 or shape(s) on the textile to identify the relevant cloth simulation parameters, and carrying the cloth simulation parameters into the cloth model 132 (direct application per arrow 136), or determining how the points of the surface of the 3D surface 128 are mapped to the virtual textile 400 and then carrying the cloth simulation parameters into the cloth model 132 corresponding to where those parameters would appear in the surface (per arrow 130).

According to some embodiments, the cloth module 104 then builds cloth model 132 using the cloth parameters in virtual textile 400. To determine which cloth parameters to take, a flat pattern 134 may be used. Flat pattern 134 may include one or more shapes that correspond to each 3D surface. Each shape 402 and 404 is applied to the virtual textile 400 (see FIG. 4A). For each shape, the cloth parameter, or cloth parameters, of the shape depends on the boundary and orientation (particularly for cloth having directional elasticity) of the shape relative to the virtual textile 400. Once the relevant cloth parameters have been determined, they are carried into the cloth model 132 for the cloth points defining the part of the 3D surface corresponding to shape (per arrow 136).

According to some embodiments, the cloth model 132 comprises a grid of points connected by springs (see e.g.. FIG. 3B) based on the virtual textile 400 (see FIGS. 4B and 4C). In some embodiments, this may be a grid of points of intersection between yarns as cloth points, connected by springs each of which is attributed the cloth parameters for the points it connects - e.g., elasticity (i.e.. spring constant), rest length, minimum length and maximum length and others as described with reference to FIGS. 4B and 4C.

According to some embodiments, as shown in FIGS. 3A and 3B, vertices of the surface 300 may map to locations (mapped locations) on T-shirt cloth model 302 (or cloth model 132) (per arrow 136 and operation 210). The mapped locations may not necessarily correspond to a cloth point on the T-shirt cloth model 302 (or cloth model 132), i.e.. the locations may not necessarily be on the intersections between yarns. For example, vertex A on surface 300 maps to a location B on T-shirt cloth model 302 between cloth points. The surface of many 3D rendered objects may be formed from a mesh of triangular polygons or other surface definition with various forms, while cloth may often be accurately represented as a rectangular arrangement of yarns. It is therefore unlikely that points on the surface 300 of a 3D rendered object or 3D surface 128 will consistently align with cloth points of a T-shirt cloth model 302 or cloth model 132.

According to some embodiments, an operation applied to the surface of a 3D surface 128 may be mapped to the simulated piece of cloth 128 with reference to the cloth model (per arrow 130). The cloth module 104 determines a response of the simulated cloth 302 to the operation. Such response may involve relative movement between cloth points. For example, if a hole 304 is cut from surface 300 of the 3D surface, the location of hole 304 will be mapped to the T-shirt cloth model 302 as hole 306. Cloth module 104 will then determine a response of the T-shirt cloth model 302 to the operation. As illustrated in FIG. 3B, cloth points (e.g., point C) at the bottom of the hole 306 may sag away from cloths points (e.g., point D) at the top of the hole. Point D remains substantially stationary, while point C moves to position C′.

According to some embodiments, after the cloth module 104 has determined the response of the cloth model 132 to the operation, the cloth module 104 identifies the new position of each mapped location on the cloth model 132. The new positions or the displacement of the mapped locations are then sent to the surface of the 3D surface to update the positions of points to correspond with the cloth model 132 (per arrow 130 and operation 214). For example, as illustrated in FIGS. 3A and 3B, point E moves to location E′. The cloth module 104 will determine the behavior in small steps - thus point C will in practice move to point C′ in a number of small steps. These small steps, when mapped back onto the surface 300 of the 3D surface 128, will appear as a smooth and realistic movement of the cloth in response to the hole 304 being cut. While this example is given with reference to the movement of points of the 3D surface 128, the operation applied to the 3D surface does not need to be applied through points of the 3D surface 128. For example, an operation applied at some location on the 3D surface 128 can be mapped to a location in the cloth model 132 (e.g., by reference to points in the 3D surface and the locations to which they are mapped in the cloth model), and the behavior of the simulated cloth 132 can then be accurately modelled.

By separating the 3D surface 128 from the cloth module 132, the response of the cloth model 132 may be determined independently of the constraints of the surface. In general, the edges of the polygons in the surface of the 3D surface 128 will not align with the springs in a simulated cloth 132. For example, elastic parameters of the virtual textile 400 on cloth model 132 cannot directly carry into the surface of a 3D surface 128. As described with reference to FIG. 4B, the elasticity of a cloth or virtual textile 400 may differ markedly depending on the direction along which a force is applied. There is therefore no readily available way of mapping elastic properties of the virtual textile 400 of cloth model 132 onto edges (which, in some embodiments may be splines or lines) of the vertices of a surface of a 3D surface 128. Moreover, some relationships, such as that defined by R1 in FIG. 4C, have no direct relationship to edges or vertices on the surface of the 3D surface 128 and thus cannot be readily modelled on a surface of the 3D surface 128.

Considering the converse, in which the behavior of the cloth is modelled directly on the surface of the 3D surface 128, since the edges or similar vertices generally do not align with the trajectories of elastic deformation parameters of a real piece of cloth or virtual textile 400, the elastic deformation parameters of the real cloth or virtual textile 400 cannot be directly applied between points of the surface of the 3D surface 128. Although some modelling software that use a mesh surface representation include additional particles or vertices into the mesh at locations of high deformation, this is undesirable as it results in inconsistent behavior across the mesh. Moreover, some relationships (e.g., that which would be defined by R1 when carried from the present cloth module 104 to the 3D surface) do not lie in the mesh of the surface of 3D surface 1 28 and therefore cannot be mapped between vertices of a mesh of the surface of 3D surface 128. regardless of the resolution of the mesh. Modelling responses of the cloth directly on the mesh or other surface representations will therefore be inaccurate in such modelling software.

According to some embodiments, cloth module 104 also determines the limits for some operations. For example, if a point is pinned (in fixed position) and another point is moved away from it, the simulated cloth between those points will be placed under tension and therefore virtual textile 400 and simulated cloth 132 will also stretch. Cloth simulation model 104 will only allow those points to become further apart until the maximum length of the virtual textile 400 or simulated cloth 132 between the two points is reached.

According to some embodiments, the response of the simulated cloth 132 to an operation may be calculated in real-time, during or on completion of the operation. Alternatively, there may be a delay between performance of the operation and the response, to provide a brief period for cancelling the operation.

According to some embodiments, flat pattern module 106 may comprise a flat pattern solver that may provide a flat pattern 134 that may be applied to virtual textile 400 or modelled on a 3D surface(s) 128 (i.e., at least one 3D surface). In other embodiments, the pattern solver may derive or generate the flat pattern 134 from the 3D surface(s) 128 (per arrow 138, step 206). Whether or not the pattern solver provides the initial pattern, the pattern solver is used to unpack the article or 3D surface(s) 128 into a flat pattern 134 at various points during the design or modelling process. Based on the 3D surface(s) 128, the pattern solver will typically produce a flat, or 2D flat pattern 134 having one or more shapes each corresponding to part of the 3D surface 128. The 3D surface 128 may therefore be reproduced by assembling the shapes (per arrow 138. operation 208, steps 220, and 240).

According to some embodiments, solving a flat pattern 134 based on an article or a 3D surface 128 may be done using known software which typically respects or preserves the boundary of shapes of a surface rather than the area of those shapes. Such software may be used for elastic materials as the stretch in the cloth will accommodate some loss of area. As this may result in an article that is not capable of properly fitting the object for which it was designed where stiffer material is used, the shapes may be further refined by a skilled designer to ensure that patterns may be physically assembled as needed. In other embodiments, solving a flat pattern 134 based on an article or a 3D surface 128 may be done using software that may preserve the area over the boundary of shapes, such that the boundary of the shape may be broken to conserve the area.

According to some embodiments, the appearance - e.g., color and topology defined by the appearance maps - of the areas on the 3D surface(s) 128 may be determined by applying the shapes 402 and 404 of the flat pattern 134 to, for example, the texture map of virtual textile 400. The shapes 402 and 404 may be applied to the texture map of virtual textile 400 by mapping the vertices, of the 3D stuface(s), that correspond to each shape to the texture map of virtual textile 400. The shapes may be moved around (e.g., shape 404 to position 406) the texture map of virtual textile 400 to change their appearance on the 3D surface(s) 128 (per arrow 138, operation 208, steps 220. and 240).

According to some embodiments, changing of the flat pattern 134 by for example, moving, rotating, editing, reshaping (such as changing shapes 402 and 404) translating or scaling would result in the execution of method 215 resulting in the rebuilding of the 3D surface.

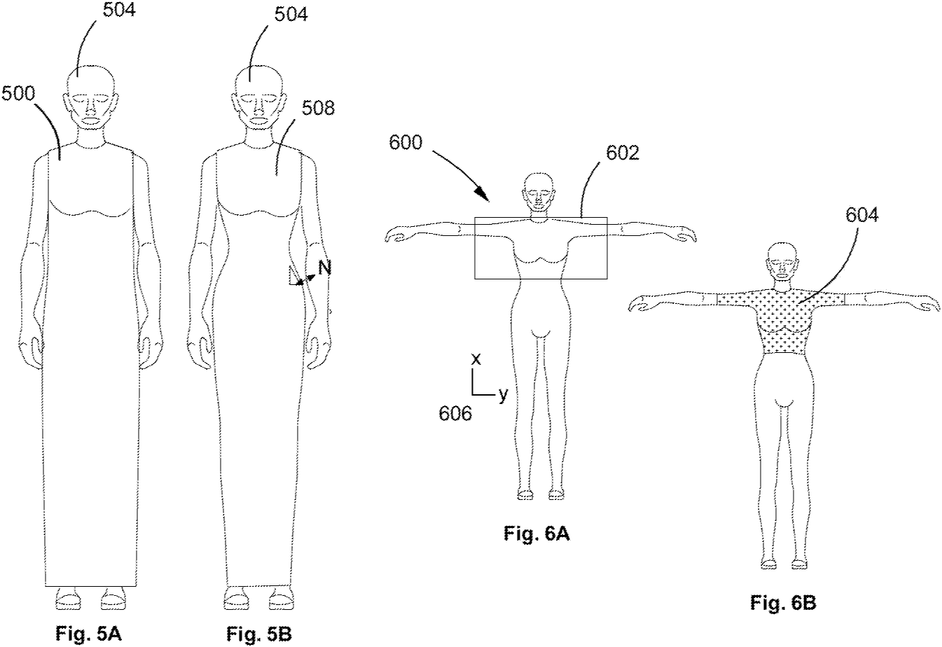

FIGS. 5A to 15B schematically illustrate various modelling tools to enable a designer to modify the article being designed on a 3D surface(s), in accordance with embodiments of the present disclosure. Each modelling tool performs a predefined operation that affects the appearance or behavior of the article. Some modelling tools may perform operations on a surface of a 3D surface 128. Other modelling tools may perform operations on the simulated piece of cloth 132 - e.g., pinning cloth points - or on the flat pattern 134 - e.g., translating or reorienting shapes of the flat pattern 134 on the virtual textile 400 (by referencing the points of the surface of a 3D surface 128 to which the shapes of the flat pattern 134 correspond, and mapping those points to the virtual textile 400). All operations may be received at the design operations module 102 either directly, when performed directly on the surface of 3D surface 128, or indirectly, when performed on the simulated cloth 132 or flat pattern 134.

According to some embodiments, some operations may result in a real-time update of one or more surfaces of 3D surface 128, flat pattern 134. or simulated cloth 132. The update of a 3D surface 128 involves displaying to a designer the effect of the operation. For example, where the modelling tool gathers cloth together, the 3D surface 218 will be updated to show the effect of that gathering action on the article.

FIGS. 5A and 5B are schematic illustrations of a process of modelling with a starting point of a previously produced article 500. in accordance with embodiments of the present disclosure. A starting point of 3D surface 128 may be a previously produced article 500 such as that shown in FIG. 5A. The previously produced article 500 has a starting fit. One modelling tool adjusts the fit of article 500, e.g., by N to generate a tighter fit 508 as shown in FIG. 5B. In this regard, base form 504 provides local minima. To avoid the article 500 being too small for the object (represented by the base form 504) for which it is being created, the created 3D surface 128 cannot violate any local minimum.

According to some embodiments, the modelling tool that adjusts the fit may take any form, for example a numerical representation or a slide bar with tighter and looser fit at respectively opposite ends.

FIGS. 6A and 6B are schematic illustrations of a process of modelling with a starting point of a blank base form 600, in accordance with embodiments of the present disclosure. The starting point may be a blank base form 600 instead of a previously produced article, as shown in FIG. 6A. Base form 600 may be shaped after any object, including a human, as illustrated in FIG. 6A. New cloth areas may be created on the base form 600 using various modelling tools. New cloth areas may be created by projecting a shape onto the base form 600 or drawing a line or lines over base form 600 to define an area on the base form 600 over which a 3D surface 128 is to be created. For example, shape 602 has been dragged over the base form 600. The shape 602 is projected (e.g., along its surface normal into/out of the page) through the base form 600. Points or lines of intersection between the projected shape 602 and the base form 600 are identified. Those points define an area of the base form 600 over which a surface or 3D surface 604 is created as shown in FIG. 6B. The resulting surface built in area 604 can be associated with a default cloth, or, if a cloth has previously been selected points of the surface within the area 604 will be mapped to locations on a piece of cloth from cloth model 132 defined by the cloth module 104 and corresponding to the selected cloth.

According to some embodiments, the flat pattern solver of the flat pattern module 106 may then solve a flat pattern 134 for the projected shape 604 and apply that flat pattern 134 to the appearance maps or virtual textile 400. The appearance defined by the appearance maps may then be imported into the 3D surface(s) as an area 604 (see FIG. 6B).

As depicted in FIGS. 6A and 6B, the base form 600 may be facing directly out of the page. Consequently, the z-axis of coordinate axes 606 extends directly into and out of the page and is parallel to the surface normal of shape 602. Given that the base form 600 is horizontally symmetrical and area 604 is centrally placed, the area 604 resulting from applying shape 602 is symmetrical on the base form 600.

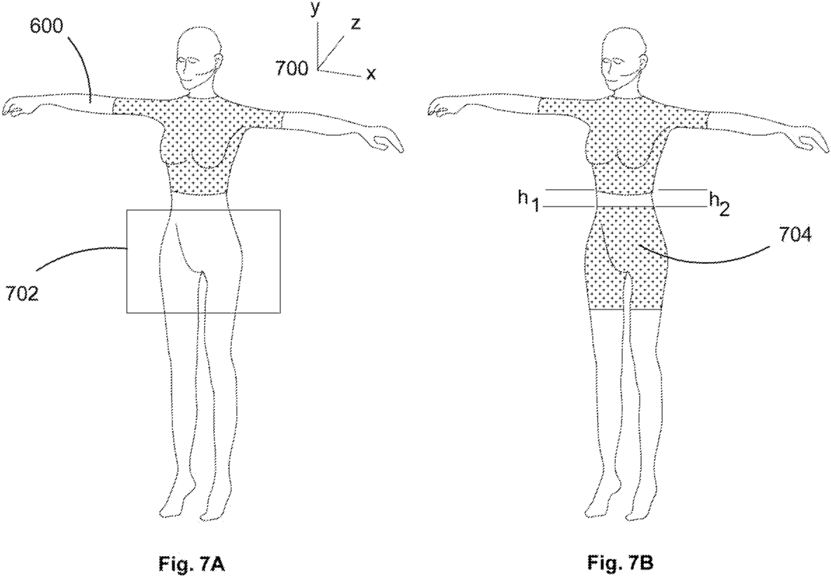

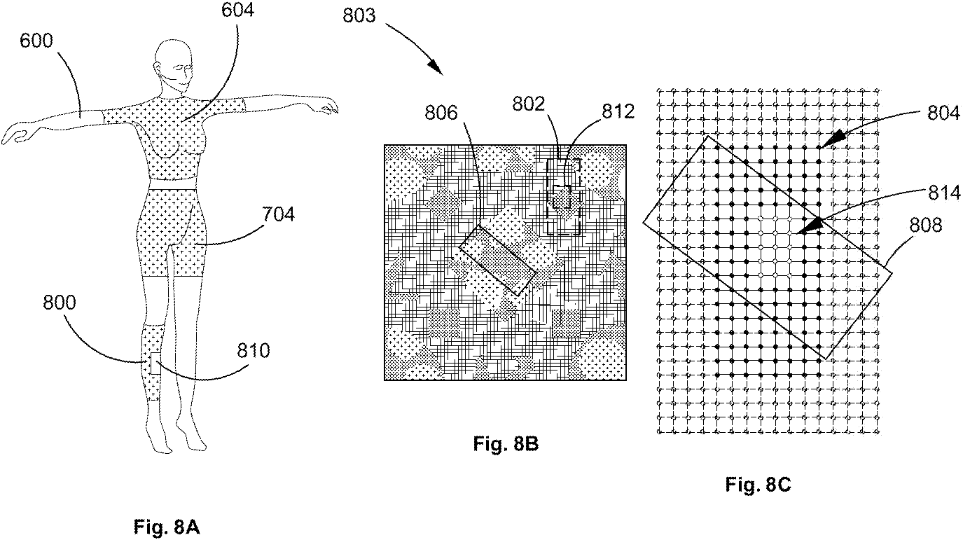

FIGS. 7A and 7B are schematic illustrations of a process of modelling with a starting point of a blank base form 600 at a different angle from that in FIGS. 6A and 6B, in accordance with embodiments of the present disclosure. As depicted in FIGS. 7A and 7B, base form 600 may be presented at an angle 700 to the shape 702 being applied (i.e., their surface normal are non-parallel). Since the surface normal of the shape 702 is not parallel with any axis of the base form 600, the new surface area 704 is asymmetrical - height h1 is marginally larger than height h2. This is more clearly shown in FIG. 8A, in which a further area 800 has been applied.

According to some embodiments, regions 504, 604 and 700 have been created by projecting a shape (which may similarly be created by drawing lines over the base form corresponding to where edges of the shape cross the base form) through the full depth of the base form 600. In other cases, axes, lines, and planes may be drawn through the base form 600 that limit the projection of the shape through the base form 600. As such, rather than any particular region wrapping around the base form 600 a region may instead be applied, for example, to the front half of the base form. The region will be pinned to the base form to prevent it falling to the ground until it is connected to other parts of the article - i.e., the cloth model will not be applied at an inconvenient time.

FIGS. 8A to 8C are schematic illustrations of a process of mapping points of an area projected on a base form 600 onto a virtual textile 803 and cloth model 804 in cloth module 104. in accordance with some embodiments of the present disclosure. Once a new area is defined on the base form 600, the points of that area may be mapped to virtual textile 803 and cloth model 804 in the cloth module 104 (per arrow 136, operation 208). For example, when a patch 800 is added to a base form 600, flat pattern solver of flat pattern module 106 resolves the patch 800 into shape 802 and applies that shape to a virtual textile 803 as illustrated in FIG. 8B. This gives the patch 800 an appearance defined by the relevant areas on the appearance map of virtual textile 803. The orientation of the shape 802 on the virtual textile 803 would determine the cloth simulation parameters used to build cloth model 804 (cloth points shown in solid lines), as illustrated in FIG. 8C. In some embodiments, the cloth model may be represented in relation to points and springs in a grid topology and may also contain all relevant cloth simulation parameters.

According to some embodiments, the operation may instead, or in addition, result in a change of appearance. Shape 802 may be translated in the virtual textile 803 to position 806. which has a different appearance and will therefore look different when applied to the 3D surface.

According to some embodiments, the operation may instead, or in addition, result in a change in behavior. When the shape 802 is moved to position 806 it is reoriented. This reorientation changes the direction of the elastic deformation parameters relative to the boundary of the shape, as reflected by simulated piece of cloth within boundary 808 illustrated in FIG. 8C.

According to some embodiments, the operation may instead, or in addition, result in removal of a region or regions from a surface of 3D surface 128. For example, section 810 may be removed from patch 800 in FIG. 8A. Such change is reflected on virtual textile 803 such that shape 802 is altered by the removal of section 812. The cloth model 804 is then altered by removal of cloth points 814 (filled white).

FIGS. 9A to 14G schematically illustrate various pin modelling tools to replicate using pins when a designer is manually designing, in accordance with embodiments of the present disclosure. For example, a designer may use pins to hold fabric in place when working on a mannequin. This process is sometimes called “draping”, generally referring to creating or drafting garment shapes in fabric in a studio. During the draping process, fabric is pinned onto a dress form, or to other pieces of fabric. In some embodiments, the system and method may include pin modelling tools recreate the intuitive experience of working with pins in real life and allow additional operations to be performed to increase the degrees of freedom and convenience over those available in real life manipulation of cloth.

According to some embodiments, each pinned point may be a location in the cloth model 132 (pinned location). The cloth properties are constraints applied at that location. Pinning a point adds one or more additional constraints to the associated location in the cloth simulation. The additional constraint(s) further restrict movement of the pinned point. The movement of cloth between the pinned points is resolved by the cloth module 104, within the bounds of the relationships between the cloth points and the pinned locations.

According to some embodiments, each pin modelling tool may perform a pin operation, being one of a point-to-point pinning operation or a transformation of a location in the cloth model relative to one or more other locations in the cloth model. A transformation may be one of fixation, rotation, translation, scaling and distribution, or other transformations as desired. The user will appear to apply the pinning operation on a 3D surface 128. The location(s) at which the operation is applied are mapped to the cloth model 132 and constraints are added in the cloth model 132 (per arrow 130). Thus, the point-to-point pinning operation or transformation will appear to be a transformation of a pin relative to one or more other pins or features (e.g., embellishments) of the 3D surface 128, yet the actual pinning operation is applied in the cloth model 132. In some embodiments, the transformation may be applied on a surface of a 3D surface 128 and the location(s) at which the transformation is applied is/are mapped to locations in the cloth model 132 at which the additional constraint(s) are applied.

FIGS. 9A to 9C are schematic illustrations of a process of using a first pin modelling tool or a pinning tool on a simulated piece of cloth 902, in accordance with embodiments of the present disclosure. The pinning tool applies a pin (i.e., fixes) at a point (i.e., location) in the simulated piece of cloth 902. Presently, points 900a and 900b are pinned (FIG. 9A). While points 900a and 900b are fixed, point 900c is translated to location 900c′ (FIG. 9B). During translation of point 900c, the simulated piece of cloth 902 responds. In some embodiments, while performing an operation, features of the workspace that are not being operated on may be hidden. For example, points 900a and 900b may be hidden during translation of point 900c. This reduces visible workspace clutter in a manner that is not achievable in the real world and enables the user to judge the design visually. The same translation operation may be performed at any arbitrary point in the simulated piece of cloth - see, e.g., the result of a pinning operation on point 900d in the 3D surface shown in FIG. 9C.

According to some embodiments, the pinning tool may also produce a point-to-point pinning operation. In this operation, one location in the simulated cloth is pinned to another location in the simulated cloth.

FIGS. 10A to 10D are schematic illustrations of a process of using a second pin modelling tool or a pin group tool on a simulated piece of cloth 1000. in accordance with embodiments of the present disclosure. The pin group tool applies a common operation to all pins in the group - e.g., fixes the group relative to each other and/or another pin, translation, rotation, and scaling of the group. A pin group may be created by selecting the pin group operation and applying the pin, or by selecting multiple pins previously placed - e.g., using the pin modelling tool - and then grouping those pins into a pin group. As illustrated in FIG. 10A, simulated piece of cloth 1000 may be held by a pin group comprising pins 1002, 1004 and 1006. FIG. 10B shows a translation of the pin group with reference to sphere 1008, in the direction of translation arrow T. FIG. 10C shows rotation in the direction of rotation arrows R about an axis heading into the page. The axis may instead be defined along any trajectory as desired. FIG. 10D shows a scaling operation, in which the magnitude of all vectors between the pins in the group are reduced. In some embodiments, the distances between all pins in the group may be proportionally reduced when scaling. In other embodiments, the distances between all the pins in the group may be reduced in different proportions when scaling.

FIG. 11 is a schematic illustration of a third pin modelling tool or a pin line tool on simulated pieces of cloths 1108 and 1110, in accordance with embodiments of the present disclosure. Pin lines created by the pin line tool may operate like a line of infinitely many pins, akin to basting or a thread, or pins spaced along a line (similar to a pin group). A pin line may be created by drawing or projecting a curve on the 3D surface 218 that is mapped to its location in the simulated piece of cloth 132 and designating that curve to be a pin line. The curve may be drawn according to any of the other embodiments described herein in relation to the drawing and projection of curves. FIG. 11 shows various pin lines 1100. 1102, 1104 and 1106 on pieces of cloth 1108, 1110, including pin line 1104 bridging the pieces of cloth 1108, 1110.

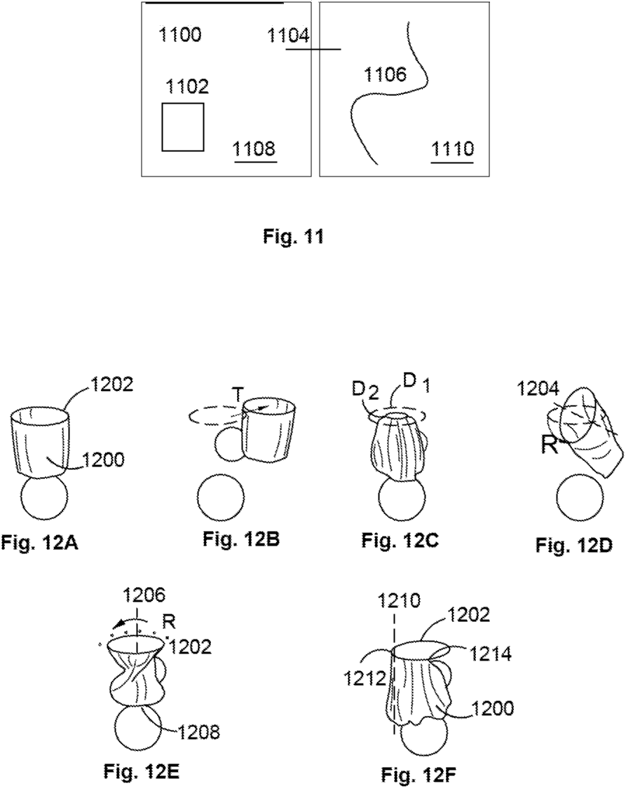

FIGS. 12A to 12F are schematic illustrations of operations carried out with using a pin line tool on a top edge of a simulated cloth 1200, in accordance with embodiments of the present disclosure. FIG. 12A illustrates a pin line 1202 created by selecting the top edge of simulated cloth 1200 and defining a pin line 1202 along that edge. FIG. 12B illustrates translation of the pin line 1202 in the direction of translation arrow T. FIG. 12C illustrates scaling of pin line 1202, such that the scaling is radially inwardly from diameter D1 to diameter D2. FIG. 12D illustrates a rotation of pin line 1202 about axis 1204 in the direction of arrow R. FIG. 10E illustrates a rotation of pin line 1202 about axis 1206 in the direction of arrow R, while the bottom edge 1208 is also pinned. FIG. 12F shows scaling along a path defined the pin line 1202. Point 1212 is fixed and point 1214 is moved by the designer along the pin line 1202 to scale the pin line 1202. This scaling operation reduces the distance between all points located between points 1212 and 1214 (inclusive), similar to the pin modelling tool and pin group modelling tool such that the simulated cloth 1200 gathers (i.e., the distances between cloth points are reduced) as shown in FIG. 12F.

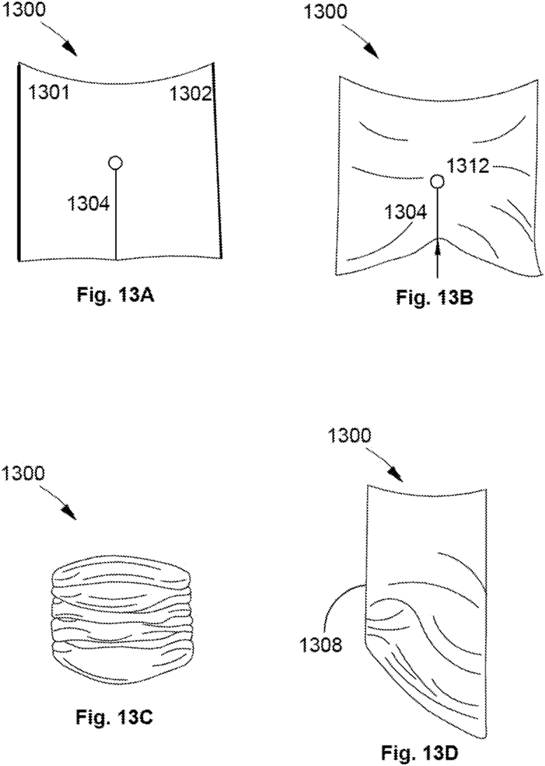

FIGS. 13A to 13D schematically illustrate results of some scaling operations using a pin line tool on a simulated piece of cloth 1300, in accordance with embodiment of the present disclosure. FIG. 13A illustrates pin lines 1301 and 1302 located along the edge boundaries of simulated cloth 1102, and pin line 1304 located at an arbitrary position between pin lines 1300 and 1302. FIG. 13B illustrates scaling down of points along line 1304 with respect to pivot 1312. In some embodiments, scaling up may also be performed, within the maximum length constraint of the locations in the cloth simulation to which the pin line 1304 maps.

According to some embodiments, the operation reflected in FIG. 13B is performed by adding pivot 1312 and performing the scaling operation on the simulated cloth with reference to the pivot 1312. Pivot 1312 need not be placed on the simulated cloth 1300 or its surface. In practice, the interface may appear as though the user or designer is applying pins onto the surface or 3D surface. However, while that may occur in some embodiments, in other embodiments the pins may be applied to locations in the simulated cloth 1300 by reference to where to designer wishes to observe the behavior of those pins on the 3D surface 128. In some embodiments, pivot 1312 may be placed anywhere and any associated operations may still be performed relative to the pivot 1312. For example, a pivot 1312 may be spaced from the article and thus from the simulated cloth 1300, with scaling operations at multiple locations on the simulated cloth 1300 all being made with reference to (i.e., towards) the pivot 1312. Similarly, simulated cloth 1300 may be added or stretched towards the pivot, while respecting the maximum length elastic deformation properties of the cloth.

FIG. 13C illustrates a result 1306 of down scaling along pin lines 1301 and 1302 at opposite edges of a piece of cloth 1300 towards the center of the edges. FIG. 13D illustrates another edge scaling operation applied along one edge 1308 of cloth 1300.

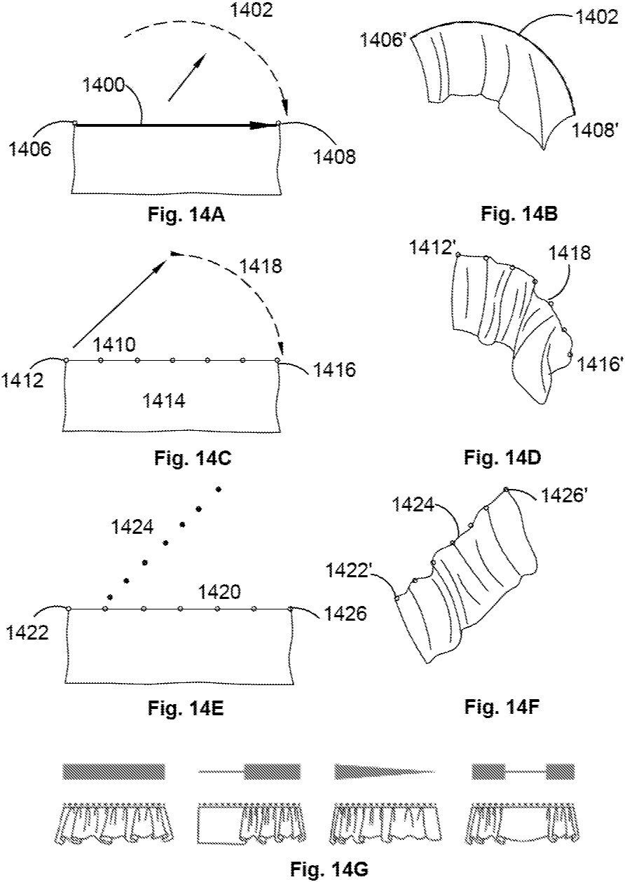

FIGS. 14A to 14G schematically illustrate various translations of a pin line, in accordance with some embodiments of the present disclosure. Pin line modelling tool enables a line-to-line translation function. The line-to-line translation function translates the pin line and the associated mesh. Pin lines will typically be directional, as indicated by pin line 1400 in FIG. 14A having an arrow end. A line 1402 to which the pin line 1400 maps is also directional. This ensures an order of the pins along the pin line is preserved during translation.

According to some embodiments, the line to which a pin line is translated may be of different length and/or shape to the pin line. For changes in shape, the pin order is preserved, and the pin line is bent onto the target line. If the pin line is longer than the target line, the position of each pin along the pin line may be normalized to the length of the target line - or both the pin line and target line pin positions are normalized - to enable the pins to be mapped to their new locations. If the pin line is shorter than the target line, it retains its length and is dropped onto the target line based on a point on the pin line (e.g., that at which it is picked up) being match to a point on the target line (e.g., the point at which the pin line is dropped off). This enables pieces of an article to be designed separately, and then attached - e.g., a sleeve may be designed and then attached to a sleeve hole on a torso portion of a garment. In another embodiment, a trim may be designed and then attached to (or repeated along) the edge of a sheet or curtain.

FIGS. 14A and 14B illustrate a translation of pin line 1400 (infinite pins) to curved, directional line 1402 (as shown by its arrow shape). FIGS. 14C and 14D illustrate a translation of pin line 1404 (discrete pins) from pin 1412 to pin 1416 to directional, target line 1418 from pin 1412′ to pin 1416′. FIGS. 14E and 14F illustrate a concurrent translation and rotation of pin line 1420 from pin 1422 to pin 1426 onto pin line 1424 from 1422′ to pin 1426′. The pin line may be scaled or bent during translation, within the limits set by the elastic deformation parameters. FIG. 14G illustrates various translation operations that may be carried out with a single piece of cloth over a pin line.

According to some embodiments, directionality of a pin line or pin group may be determined by the order of selection of pins or by separately specifying that direction. Thus, the directionality of the pin line and target line can be matched to ensure the desired pin order is preserved.

As described with reference to FIGS. 9A to 14G, pins and pin lines are points and curves a designer can use to easily manipulate cloth model 132 and have changes carried into the 3D surface 128 in real-time. Pins and pin lines are analogous to thread or many pins but are more versatile. Pin lines may be made with any curve on cloth objects - simulated pieces of cloth. Pin lines may take any form, including closed loops, and can bridge between pieces of material. A pin line may be removed or deleted.

According to some embodiments, the pin modelling tool, pin group modelling tool and pin line modelling tool enable individual pins, pin groups (including an infinite collection of pins on a pin line) to be translated and in some embodiments rotated, scaled, and redistributed. Each of these operations may be performed by dragging a mouse pointer, or finger contact on a touchscreen, from the current position of the pin, pin group or pin the line to the desired position.

According to some embodiments, pinning operations such as those described in relation to FIGS. 9A to 14G may constrain cloth points in 3D space or with respect to a location in 3D space defined by a coordinate on a curve or surface. In contrast, spring-based operations, or cloth parameter operations, constrain two or more cloth points with respect to one another. In this regard, a cloth topology may be considered as a grid or distribution of cloth points, connected by springs where properties of the springs are defined by cloth parameters taken from the virtual textile.

According to some embodiments, particular points may be fixed in pinning operations and thus may be unaffected by cloth simulation. Unlike pinning operations, in regions of the simulated cloth on which cloth parameter operations are performed, the affected cloth points are not precluded from the cloth simulation. Instead, the cloth parameter operations locally effect or adjust cloth parameters to which the operations are applied. The resultant positions of the relevant cloth points are then determined by the cloth simulation, subject to the modified spring constraints (cloth parameters). Therefore, the cloth points and the deformations (appearance of the 3D surface) created by such operations are subject to more cloth behavioral factors, such as collisions with other surfaces and manipulation of other cloth points.

For example, FIGS. 12F and 13B to 13D show pin line gathering operations in which the pin line remains fixed in space. In contrast, for bringing together cloth points, such as sewing or gathering, between which springs or cloth parameters are already defined, the relevant elastic deformation parameter values of those springs can be modified. This leaves the cloth points unfixed, and therefore able to move in response to cloth simulation.

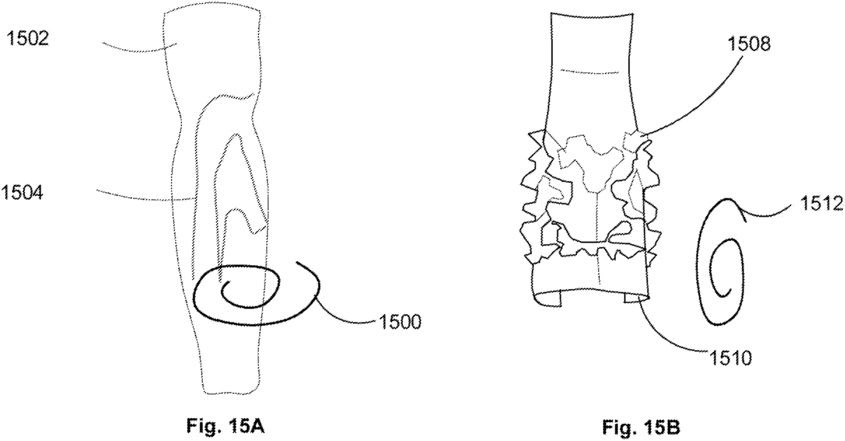

FIGS. 15A and 15B schematically illustrate a curve modelling tool that may apply curves to a 3D surface 128, in accordance with embodiments of the present disclosure. The curve may lie along or across one or more regions defined by points of the surface. The surface may then be edited using the curve. While a curve may be drawn directly on a 3D surface, the designer may instead draw a curve separate from a 3D surface (the basis curve). Similar to shape 602 of FIG. 6A, the curve may then be projected onto a 3D surface. Points of intersection between the curve and 3D surface are identified and the curve is then produced through those points of intersection. The same process can be used to identify intersections between an object being incorporated into the article, and a 3D surface.

FIG. 15A schematically illustrates a curve 1500 projected onto a 3D surface 1502, in accordance with embodiments of the present disclosure. Curve 1500 may be drawn separately from 3D surface 1502. The curve 1500 is projected onto 3D surface 1502. Points of intersection between the curve 1500 and 3D surface 1502 may be identified and the curve 1504 may be produced on 3D surface 1502. The surface or 3D surface 1502 may then be transformed using the curve 1504. The transformation may involve placing buttons or another feature along the curve 1504. The number and distribution of buttons or other features may be adjusted as desired.

FIG. 15B schematically illustrates a curve 1512 projected onto a 3D surface 1510, such projection transformed with ruffle 1508, in accordance with embodiments of the present disclosure. In some embodiments, the transformation of a projected curve onto a 3D surface may comprise an embellishment, e.g., ruffle 1508, applied to the 3D surface 1510 using a curve defined after projecting basis curve 1512 onto the 3D surface 1512. The size of the embellishment may then be adjusted or the position, spread and continuity of the embellishment may be modified. For example, pleats may be introduced along the curve: the distance between neighboring pleats is defined by the selected spread, and the uniformity of non-uniformity of the distribution of the pleats is defined by the continuity.

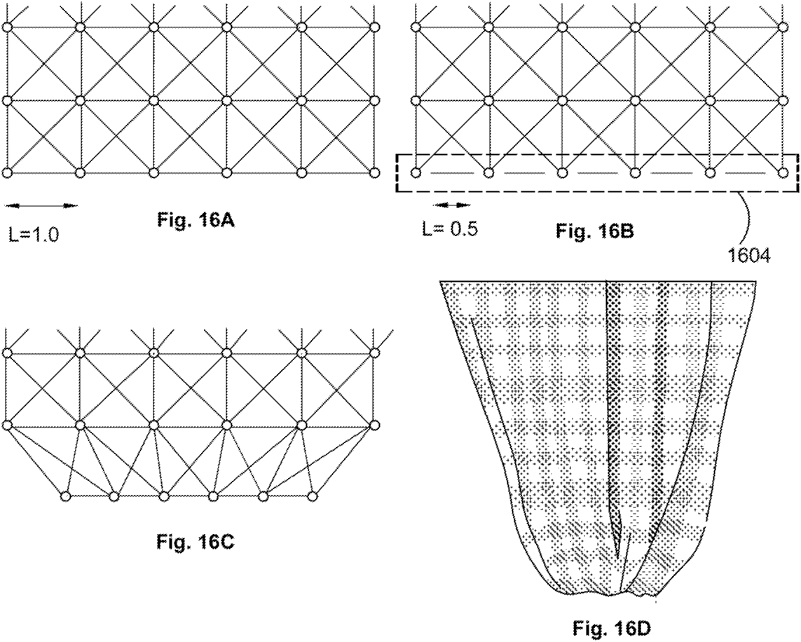

FIGS. 16A to 16D schematically illustrate a cloth model, in accordance with embodiments of the present disclosure. Cloth model may be illustrated as a grid of cloth points with springs (lines) between them. The initial length of each spring may be 1.0 unit as shown in FIG. 16A. A bottom row 1604 of points of the cloth model may be gathered by decreasing the minimum and maximum lengths of the springs between them - indicated by adjusted initial length of 0.5 in FIG. 16B. The resulting cloth model is shown in FIG. 16C and the effect on the 3D surface is shown in FIG. 16D. Notably, gathering along a pin line would have resulted in the spacing between the bottom row of cloth points being fixed. In the examples shown in FIGS. 16, the bottom row 1604 of cloth points may still move relative to each other. For example, cloth points in bottom row 1604 may move closer together as the cloth model 132 is simulated by the cloth module 104.

According to some embodiments, spring or cloth parameter operations may also perform other functions. A fold may be achieved by adjustment of the minimum and maximum lengths of springs that cross the folding axis between non-neighboring cloth points that lie immediately on either side of the folding axis. A partial exit (a cut that does not completely segment the surface into two parts) initiated at the 3D design operations module, may be implemented by removing springs that cross the cutting line. Additional cloth points may also be created on the cutting line, and springs or cloth parameters are then added between the newly created cloth points and the appropriate neighboring and non-neighboring cloth points.

According to some embodiments, other functions may be achieved by defining altogether new cloth parameters (i.e.. inserting springs) between pre-existing cloth points. Accordingly, an operation that is a spring or cloth parameter operation, may include one or more of addition, deletion, and modification of one or more of the elastic deformation parameters (spring parameters). Such operation may be received at the design operations module 102 or the cloth module 104.

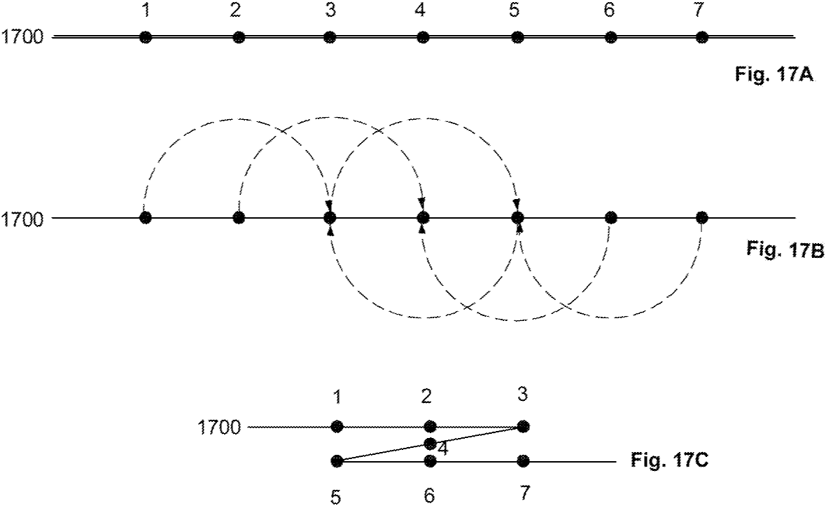

FIGS. 17A to 17C schematically illustrates a process of moving a simulated line from an initial position to a folded or pleated position, in accordance with embodiments of the present disclosure. Existing CAD software typically executes a whole operation instantaneously, in a single step. For example, when forming a pleat from a flat piece of cloth, the cloth will be folded instantaneously to its final arrangement as a pleat. This precludes proper simulation of cloth behavior since the cloth would need to move through itself to travel directly from its arrangement as a flat piece of cloth to a folded arrangement as a pleat.

According to some embodiments, when executing an operation, the system and method may define a path for each cloth point between its initial position and its final position, over which it travels to its final position over time. This is akin to the action of making a fold on a piece of paper. Each point on the piece of paper travels from an initial position to a final position over a specific path, in this case an arc, over a duration of time. The paper cannot travel from the initial position to the target position instantaneously, nor can it travel the shortest, straight path between the initial position to the target position over a non-zero duration of time. Both scenarios are impossible in reality as the surface points would have to pass through one another. They are similarly unviable in simulated reality because, while the points can theoretically pass through one another, the resulting surface will intersect with itself and this will not produce the desired result of a fold. Likewise, most, if not all, cloth manipulation operations are time-sensitive and path-sensitive. By specifying a path and duration for each selected cloth point to traverse during the operation, the cloth simulation can determine the positions of the non-selected cloth points around the transformation of the selected cloth points over the course of the operation runtime. In so doing, the simulation can create the desired cloth behavior and cloth surface deformation.

FIG. 17A illustrates a pin line or point line 1700 comprising numbered points in an initial position. The final position for that line 1700 is illustrated in FIG. 17C, with the same numbering provided on each of the points. FIG. 17B illustrates the trajectory over which each point travels, over time, between the initial position and final position.

According to some embodiments, the points of pin line 1700 may be further moved until they overlie each other, if desired. However, during movement from the initial position to the final position no such overlying will occur. Therefore, upon receiving the operation, the method may involve determining (e.g., at GPU 116) an initial position of one or more cloth points affected by the operation (the affected point(s), a final position of the affected point(s), and a trajectory over which each affected point travels between its respective initial position and final position. In general, the method may also comprise determining a period of time or number of iterations (e.g., executed as consecutive clock cycles) over which each affected point travels from its initial position to its final position. For example, affected point C in FIG. 3B may move from its initial position C to its final position (point C′) over a path, over time. Similarly, the operations resulting in movement of points in FIGS. 12A to 14G may similarly involve moving each point from its initial position (e.g., in FIG. 12A and FIG. 14A. 14C and 14E) to its final position (e.g., in FIG. 12B to 12B, and FIGS. 14B, 14D and 14F) over a path, over time. In each case, one objective is that the simulated cloth defined by the affected points should not self-intersect during simulation or execution of the operation.

It should be appreciated that the above-described methods may be varied in many ways, including omitting, or adding steps, changing the order of steps and the type of devices used. It should be appreciated that different features may be combined in different ways. In particular, not all the features shown above in a particular embodiment are necessary in every embodiment of the disclosure. Further combinations of the above features are also considered to be within the scope of some embodiments of the disclosure.

It will be appreciated that many further modifications and permutations of various aspects of the described embodiments are possible. Accordingly, the described aspects are intended to embrace all such alterations, modifications, and variations that fall within the spirit and scope of the appended claims.

Some portions of the description herein are directed to embodiments in terms of algorithmic processes or operations. These portions may be described functionally, computationally, or logically, and are understood to be implemented by computer programs including instructions for execution by a processor or equivalent electrical circuits, microcode, embedded code, or the like.

References to non-transitory computer-readable medium may include computer storage medium and communication medium including any medium that facilitates transfer of a computer program or data from one place to another. A storage medium may be any available or later developed medium that can be accessed by a computing device, such as a Universal Serial Bus drive, solid state hard drive, hard disk, network disk, network device, node, mass storage devices, streaming devices, and the like. References to computing devices may include a desktop computer, a laptop, or another computing device, a mobile computer device such as a smart phone, a personal data assistant (PDA), a palm-top computer, or multimedia or Internet enabled device or a cellular enabled device, including communication enabled devices such as telephones. Any functional and/or physical components described herein may be realized by common constructs or distributed among additional physical components. It is also contemplated that other existing and yet-to-be developed physical components and architectures may be utilized to implement the functional components described herein. In some embodiments for example, non-volatile memory may include bootloader code, modem software, operating system code, file system code, and code to facilitate the implementation components. Non-volatile memory may also be realized by flash memory (e.g., NAND or ONENAND memory), or other memory types may be utilized as well. Transceiver chains may represent transceivers associated with a particular communication scheme. For example, each transceiver may correspond to protocols that are specific to local area networks, cellular networks, such as a CDMA network, a GPRS network, a UMTS networks, and other types of communication networks. References to displays may include output devices for presenting information such as CRT. LCD, HDMI. micro-projector, flat panel displays, and OLED displays and the like. References to a video processor may include modem processor, DSP, graphics processing unit (GPU), and other video processing components. References to a computer processor may include computer circuitry that executes instructions in series, including a central processing unit (CPU), an arithmetic logic unit (ALU) an integrated circuit (IC) or other similar processing elements now existing or later developed.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

It will be appreciated by persons skilled in the art that the present invention is not limited to what has been particularly shown and described hereinabove. Rather the scope of the present invention is defined only by the claims, which follow.

1. A method of modelling a cloth article, the method comprising:
creating a 3D surface, the 3D surface is formed from a plurality of first points by a 3D design operations module;
providing a virtual textile comprising properties of a piece of cloth by a cloth module;
solving a flat pattern of the 3D surface based on virtual textile properties by a flat pattern solver;
generating a cloth model with grid topology comprising cloth points connected by springs, based on the virtual textile properties and the flat pattern:
updating a 2D mesh and a 3D mesh with the grid topology;
simulating the cloth model; and
updating the 3D surface, flat pattern, and/or cloth model based on user interactions.

2. The method of claim 1, further comprising updating the 3D surface based on simulated behavior of the cloth model.

3. The method of claim 1, wherein the properties of a piece of cloth comprise a plurality of second points, each of the plurality of second points having defined relationships with one or more of the plurality of second points.

4. The method of claim 1, further comprising generating a surface topology, the surface topology comprises:
identifying one or more pieces of cloth;
tessellating each of the one or more pieces of cloth with a grid topology, the grid topology comprising a plurality of grid points;
identifying grid points that are outside a boundary curve and adjacent to a grid point within the boundary curve; and
shifting the identified grid points onto the boundary curve.

5. The method of claim 4, wherein identifying one or more pieces of cloth comprises:
identifying and correcting curves that are not closed;
identifying and correcting curves that intersect with each other;
identifying and correcting curves that self-intersect; and
identifying one or more groups of curves, each group of curves forming a piece of cloth.

6. The method of claim 4, wherein a group of curves comprises an outermost curve and one or more curves contained within the outermost curve.

7. The method of claim 6, wherein the boundary curve comprises the outermost curve.

8. The method of claim 4, wherein tessellating each of the one or more pieces of cloth with a grid topology comprises:
creating a minimum enclosing grid;
instantiating all grid points; and
instantiating springs from a grid-space vector format.

9. The method of claim 8, wherein the minimum enclosing grid is a grid of N rows and M columns, where N is a height of a bounding box of a group of curves divided by a cloth resolution and rounded up to the nearest integer + 1, and M is a width of the bounding box divided by the cloth resolution and rounded up to the nearest integer + 1.

10. The method of claim 4, wherein shifting the identified grid points onto the boundary curve comprises identifying one or more grid patches that comprise one or more identified grid points and one or more adjacent grid points within the boundary curve, wherein each grid patch comprises four grid points arranged in a 2 × 2 configuration.

11. The method of claim 10, wherein shifting the identified grid points onto the boundary curves further comprises:
identifying one or more kink points on the boundary curves;
identifying grid patches that contain one or more kink points; and
shifting an identified grid point to the one or more kink points, wherein the shifted identified grid point is the identified grid point within the grid patch that is closest to the kink point.

12. The method of claim 10, wherein shifting the identified grid points onto the boundary curve further comprises:
identifying grid patches comprising two identified grid points and two grid points inside the boundary curve:
identifying the grid point inside the boundary curve that each identified grid point should be shifted to;
finding an intersection between the boundary curve and a line between each identified grid point and the grid point inside the boundary curve; and
shifting each of the grid points within the boundary curves to their respective intersection.

13. The method of claim 10, wherein shifting the identified grid points onto the boundary curve further comprises:
identifying grid patches comprising three identified grid points and one grid point inside the boundary curve;
discarding the identified grid point that is diagonal to the grid point inside the boundary curve;
finding an intersection between the boundary curve and each line between the grid point inside the boundary curve and each identified grid point that is orthogonal to the grid point within the boundary curve; and
shifting each identified grid point that is orthogonal to the grid point within the boundary curve to their respective intersection.

14. The method of claim 10, wherein shifting the identified grid points onto the boundary curve further comprises:
identifying grid patches comprising one identified grid point and three grid points within the boundary curve;
finding an intersection between the boundary curve and each line between each of the grid points inside the boundary curve;
determining a distance between each of the grid points inside the boundary curve and its respective intersection;
selecting the grid point inside the boundary curve with the smallest distance to its respective intersection; and
shifting the identified grid point to the intersection of the selected grid point inside the boundary curve.

15. The method of claim 4, further comprising:
calculating a rest length between pairs of second points having a defined relationship; and
writing a mesh for the 3D surface while in 2D space.

16. The method of claim 15, further comprising:
identifying one or more new grid points generated;
identifying a face and coordinate for each of the one or more new grid points;
identifying a position on the 3D surface for each of the one or more new grid points; and
attaching any new coincident boundary curve pairs.

17. An apparatus for modelling a cloth article, the apparatus comprising:
a memory and a processor, the processor operably coupled to the memory; and
a display coupled to the processor, the processor operating one or more modules selected from the group comprising a design operations module providing a 3D surface, a cloth module providing a cloth model, and a flat pattern module comprising a flat pattern solver providing a flat pattern; and
wherein the memory stores instructions that, when executed by the processor, cause the processor to control the design operations module, cloth simulation module and flat pattern solver to perform the method of claim 1.

18. A computer readable medium having instructions stored thereon that when executed by a processor of a computer system, causing the computer system to perform the method of claim 1.

19. The method of claim 1, wherein user interactions comprise rotation or translation of constrained points in the cloth model, adding cloth to the 3D surface, cutting cloth away, adding, deleting or rewriting of points and springs, or any combination thereof.

20. The method of claim 1, further comprising constraining cloth points in 3D space or with respect to a location in 3D space defined by a coordinate on a curve or surface.

21. The method of claim 1, further comprising constraining two or more cloth points with respect to one another.

22. The method of claim 1, further comprising determining a path and duration for each selected cloth point to traverse during a user interaction, wherein positions of non-selected cloth points are determined during simulating the cloth model, around transformation of the selected cloth points over a course of the user interaction runtime to thereby create a desired cloth behavior and cloth surface deformation.
